(19) United States
(12) Patent Application Publication
(10) Pub. No.: US 2023/0273108 A1
(43) Pub. Date: Aug. 31, 2023

(54) MICROPARTICLE ANALYSIS DEVICE, MICROPARTICLE SORTING SYSTEM, AND MICROPARTICLE ANALYSIS METHOD

(71) Applicant: SONY GROUP CORPORATION, TOKYO (JP)

(72) Inventors: SHIN MASUHARA, TOKYO (JP); MASAHIKO NAKAMURA, TOKYO (JP); MASAHIDE FURUKAWA, TOKYO (JP)

(21) Appl. No.: 18/005,650

(22) PCT Filed: Jun. 16, 2021
(86) PCT No.: PCT/JP2021/022773

§ 371 Date: Jan. 16, 2023

(30) Foreign Application Priority Data
Jul. 28, 2020 (JP) 2020-127147

(51) Int. Cl. G01N 15/14

(52) U.S. Cl. CPC G01N 15/1404; G01N 15/1434; G01N 2015/149; G01N 2015/1481

(57) ABSTRACT

To provide a technique capable of stably forming droplets.

There is provided a microparticle sorting device and the like including: an imaging element configured to acquire an image of fluid and a droplet at a position where liquid discharged from an orifice that generates a stream of the fluid is converted into a droplet; and a processing unit configured to determine a harmonic superposition amplitude ratio, a harmonic phase difference, and a superimposed wave voltage on the basis of states of a satellite droplet and a break-off point in the image.

### TECHNICAL FIELD

The present technology relates to a microparticle analysis device, a microparticle sorting system, and a microparticle analysis method.

### BACKGROUND ART

Various devices have been developed so far for sorting microparticles, and in particular, a device for sorting cells is called a “cell sorter”. In a cell sorter, generally, by applying vibration to a flow cell or a microchip by a vibration element or the like, fluid discharged from a flow path is converted into droplets. After a positive or negative electric charge is applied to the droplets separated from the fluid, a traveling direction of the droplets is changed by a deflection plate or the like, and the droplets are collected in a predetermined container or the like.

In a flow cytometer, a control technique for stably forming droplets is one of important factors for improving accuracy of sorting. Here, it is known that, when formation of droplets is unstable, such as when a break-off point (BOP) at which fluid discharged from a discharge port of the flow path is converted into droplets is unstable, time during which the droplets are charged with the electric charge also becomes unstable, resulting in unstable sorting of the microparticles. However, in the formation of droplets, a plurality of factors is involved such as environmental conditions such as a flow velocity, a temperature, and a humidity, and a size of the microparticle, and thus it is difficult to control the formation.

On the other hand, for example, Patent Documents 1 and 2 disclose a technique of acquiring an image of droplets by using an imaging element or the like, controlling a drive voltage to be applied to a vibration element on the basis of the image, and stabilizing a break-off timing.

### CITATION LIST

### Patent Document

Patent Document 1: Pamphlet of International Publication No. 2014/115409
Patent Document 2: Japanese Patent Application Laid-Open No. 2017-122734

### SUMMARY OF THE INVENTION

### Problems to be Solved by the Invention

However, there has been an actual situation in which further development of a technique for stably forming droplets is desired.

Therefore, a main object of the present technology is to provide a technology capable of stably forming droplets.

### Solutions to Problems

In the present technology, first, there is provided a microparticle sorting device including: an imaging element configured to acquire an image of fluid and a droplet at a position where liquid discharged from an orifice that generates a stream of the fluid is converted into a droplet; and a processing unit configured to determine a harmonic superposition amplitude ratio, a harmonic phase difference, and a superimposed wave voltage on the basis of states of a satellite droplet and a break-off point in the image.

In the present technology, the harmonic superposition amplitude ratio may be determined on the basis of a maximum value and a minimum value of an amplitude ratio.

In the present technology, a phase difference may be rotated, and the harmonic superposition amplitude ratio may be determined on the basis of a state of a break-off point in the image, the state being associated with a phase change.

In the present technology, the harmonic phase difference may be determined at an angle at which a length of the break-off point in the image is minimized.

The present technology may further include: a vibration element configured to apply vibration to liquid flowing through a flow path that generates a stream of a fluid; and a vibration application control unit configured to cause operation to make a displacement waveform of the vibration element to be asymmetric in a time axis direction between a pushing operation and a pulling operation.

In the present technology, a displacement waveform of the vibration element may be a superimposed frequency of: a sinusoidal wave of a basic frequency; and a harmonic of an integral multiple frequency of the basic frequency.

In the present technology, a frequency of the harmonic may be one type of frequency separated from a resonance frequency of the vibration element by ±10 kHz or more.

In the present technology, the flow path may be formed in a microchip.

In the present technology, the microchip may further include: a main flow path through which liquid containing a microparticle flows; a sheath liquid flow path that communicates with the main flow path and supplies sheath liquid; and a sheath liquid introduction unit configured to introduce the sheath liquid.

The present technology may further include a connection member attachable to the microchip and having a sheath liquid introduction coupling part to be coupled to the sheath liquid introduction unit.

In the present technology, the vibration element may be attached to the connection member.

In the present technology, the sheath liquid introduction coupling part may have a sheath liquid converging part whose width gradually or partially decreases from the vibration element side toward the sheath liquid introduction unit side.

Furthermore, in the present technology, there is also provided a microparticle sorting device including: a light irradiation unit configured to irradiate a microparticle with light; a light detection unit configured to detect light from the microparticle; an imaging element configured to acquire an image of fluid and a droplet at a position where liquid discharged from an orifice that generates a stream of the fluid is converted into a droplet; and a processing unit configured to determine a harmonic superposition amplitude ratio, a harmonic phase difference, and a superimposed wave voltage on the basis of states of a satellite droplet and a break-off point in the image.

Moreover, according to the present technology, there is also provided microparticle sorting system including: an imaging device configured to acquire an image of fluid and a droplet at a position where liquid discharged from an orifice that generates a stream of the fluid is converted into a droplet; and a processing device configured to determine a harmonic superposition amplitude ratio, a harmonic phase difference, and a superimposed wave voltage on the basis of states of a satellite droplet and a break-off point in the image.

In addition, in the present technology, there is also provided a microparticle sorting method including: an imaging step of acquiring an image of fluid and a droplet at a position where liquid discharged from an orifice that generates a stream of the fluid is converted into a droplet; and a processing step of determining a harmonic superposition amplitude ratio, a harmonic phase difference, and a superimposed wave voltage on the basis of states of a satellite droplet and a break-off point in the image.

### BRIEF DESCRIPTION OF DRAWINGS

FIG. 1 is a view for explaining a satellite state of droplets.

FIG. 2 is a view for explaining a difference in a deflection result depending on a satellite state.

FIG. 3 is a view for explaining a FAST satellite generated when foreign matter is mixed.

FIG. 4 is a view for explaining a deflection action abnormality when droplet jitter occurs.

FIG. 5 is a view illustrating a configuration example of a microparticle analysis device according to a first embodiment.

A and B of FIG. 6 are views illustrating a configuration example of a microchip.

A to C of FIG. 7 are views illustrating a configuration example of an orifice of the microchip.

FIG. 8 is a view illustrating a configuration example of the microchip and a connection member.

A and B of FIG. 9 are views illustrating a configuration example when the present technology is applied in a case where a flow path is formed in a flow cell.

FIG. 10 is a view illustrating a calculation result of a satellite transition in a case where a flow velocity fluctuation of 2f is added to a basic frequency f.

FIG. 11 is a graph illustrating a superimposed waveform of a sinusoidal wave and a second harmonic in three types of phase differences.

FIG. 12 is a diagram illustrating a configuration example of a signal generation unit.

FIG. 13 is a view illustrating a satellite behavior associated with a change in phase difference Δφ of a harmonic Wh.

FIG. 14 is a graph illustrating a BOP length behavior associated with a change in phase difference Δφ of the harmonic Wh.

FIG. 15 is a diagram illustrating a configuration example of a microparticle sorting device according to a second embodiment.

FIG. 16 is a flowchart illustrating an example of a flow of a microparticle sorting method according to the present technology.

FIG. 17 is a flowchart illustrating an example of a flow of the microparticle sorting method according to the present technology.

FIG. 18 is a flowchart illustrating an example of a flow of the microparticle sorting method according to the present technology.

FIG. 19 is a graph illustrating an example of frequency characteristics of a piezo actuator.

FIG. 20 is a view illustrating a difference between a piezo drive waveform and a piezo actuator vibration waveform.

FIG. 21 is a view illustrating a result of observing a state of a satellite while rotating a phase of Wh by 360° with R=½.

FIG. 22 is a view illustrating a result of observing a state of a satellite while rotating a phase of Wh by 360° with R=⅙.

FIG. 23 is a view illustrating a result of observing a state of a satellite while rotating a phase of Wh by 360° with R= 1/12.

A of FIG. 24 is a view illustrating an example of a superimposed waveform with R=⅙, and B of FIG. 24 is a view illustrating an example of a superimposed waveform with R= 1/12.

FIG. 25 is a view illustrating a deflection action of 100-kHz_FAST-satellite droplets generated by a superimposed wave of R=⅙.

### MODE FOR CARRYING OUT THE INVENTION

Preferred embodiments for implementing the present technology will be described below with reference to the drawings.

The embodiments described below show one example of a representative embodiment of the present technology, and do not cause the scope of the present technology to be narrowly interpreted. Note that the description will be given in the following order.
1. Main problem and basic concept of present technology
2. First embodiment (microparticle sorting device 100)
(1) Imaging element E
(2) Processing unit 105
(3) Flow path
(3-1) Microchip M
(3-2) Flow cell
(3-3) Connection member C
(3-4) Modification
(4) Verification example by simulation
(5) Each parameter determination procedure on device
3. Second embodiment (microparticle sorting device 100)
(1) Light irradiation unit 103
(2) Light detection unit 104
(3) Droplet formation unit
(4) Sorting unit 106 (including charging unit 106c)
(5) Storage unit 107
(6) Display unit 108
(7) Input unit 109
(8) Control unit 110
4. Third embodiment (microparticle sorting system)
5. Fourth embodiment (microparticle sorting method)
(1) Flow example 1
(2) Flow example 2
(3) Flow example 3
(4) Other

### 1. Main Problem and Basic Concept of Present Technology

In general, in a microparticle sorting device, after sample liquid containing microparticles is discharged from a nozzle having a diameter of about 100 μm, microparticles are brought into a state of being individually converted into droplets, and a positive, zero, or negative charge is applied on the basis of a detection signal obtained from immediately preceding light irradiation. Furthermore, a trajectory is divided according to the charged state by a high-voltage deflection electrode, and the droplets are collected in individual collection containers. Therefore, in order to cause the microparticle to reach a desired collection container stably for a long time, precise control of the droplets without temporal fluctuations and variations is required.

Hereinafter, a general droplet forming method will be described in detail.

Before being discharged from the nozzle as a jet and converted into droplets, liquid flowing in the device includes sample liquid containing microparticles and sheath liquid that is for conveyance and forms a laminar flow with the sample liquid to externally enclose the sample liquid. Since the sheath liquid contains salt, the sheath liquid has conductivity and can provide an electric charge. When vibration of a constant frequency f is applied directly to the liquid or to a periphery of a flow path through which the liquid flows by using a vibration application unit, the liquid is converted into droplets at a constant interval λ=V/f with respect to a flow velocity V of the jet within about 10 mm after nozzle discharge.

This phenomenon is explained by a mechanism in which a condensation and rarefaction state of a cycle z due to a flow velocity change is formed inside a jet flow by applying vibration, and a surface tension gradually amplifies an initial minute constriction induced therefrom, and the liquid is finally divided into droplets. In a general microparticle sorting device, the flow velocity V is 10 m/s to 50 m/s, and the frequency f is 20 to 200 kHz. Furthermore, a nozzle diameter d is 50 to 200 μm, and conversion into droplets occurs in a case of the droplet interval λ=V/f≥3.14×d according to a linear theory of Rayleigh, and λ=4.5×d is recommended as a condition under which droplets are most efficiently generated.

Next, satellite droplets which greatly affect deflection accuracy of droplets will be described in detail.

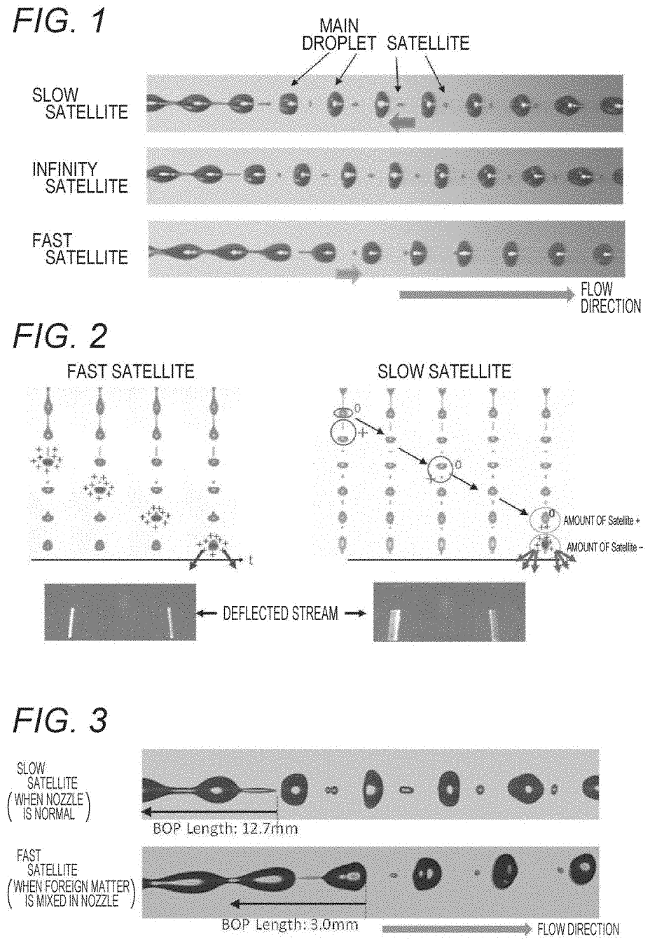

Immediately after the jet flow is divided into droplets, a state is established in which microdroplets called satellites having a diameter of 1/10 or less with respect to a diameter of main droplets are present between the main droplets. This is obtained when a constriction part having a final form that has become a thread shape immediately before the division into droplets is spontaneously spheroidized due to the action of surface tension, after being separated from front and rear droplets. When the satellite in a state of a liquid thread before growth is cut from the front and rear main droplets, a relative velocity with respect to the main droplets is changed by a timing difference between the two, resulting in one of the following three kinds (see FIG. 1).

(a) SLOW satellite: A case where a satellite velocity is lower than a main droplet velocity and the satellite is collected into the rear main droplet is referred to as a “SLOW satellite”. This occurs in a case where the liquid thread is cut early from the front main droplet before being cut from the rear main droplet.

(b) INFINITY satellite: A case where a satellite velocity is substantially equal to a main droplet velocity and the satellite is not collected into the main droplet is referred to as an “INFINITY satellite”. This occurs in a case where the liquid thread is simultaneously cut from the front and rear main droplets.

(c) FAST satellite: A case where a satellite velocity is faster than a main droplet velocity and the satellite is collected into the front main droplet is referred to as a “FAST satellite”. This occurs in a case where the liquid thread is cut early from the rear main droplet before being cut from the front main droplet.

Here, the FAST satellite is recommended in a case where the droplet is stably deflected at a certain angle. Hereinafter, the reason will be described in detail (see FIG. 2).

Charging of ±a few hundred volts to droplets is performed via a conductive jet flow from electrodes attached to a flow path housing, at a moment the jet flow is divided into droplets. In the case of the SLOW satellite, since a satellite SA of a previously charged droplet A is collected into a droplet B, a charge amount of the front satellite SA, although a ratio is low, is given as a charge amount of the droplet B in addition to a charge amount directly charged to itself. The charge amount of SA is unrelated to B, and three values can be taken depending on whether SA is positively charged, uncharged, or negatively charged.

As described above, in both positively charged droplets and negatively charged droplets, since there are three stages of the charge amount, the deflection angle is also slightly separated accordingly. However, if the charging timing is accurately adjusted at a time of droplet dividing, it is also possible to deflect the SLOW satellite in one direction of positive and negative each. However, as the frequency increases, a time margin for the charge timing adjustment decreases, and a charging rectangular pulse on the order of several microseconds starts to be blunted in a triangular wave shape in an electric circuit, and can no longer be made sufficiently shorter than a droplet cycle. Therefore, it is practically difficult to stably maintain the unidirectional deflection state at 50 kHz or more.

Whereas, in the case of the FAST satellite, as illustrated in FIG. 2, a charge polarity of the satellite SA generated rearward of the droplet A is the same as that of the droplet A, and the satellite SA is collected into the droplet A again. Therefore, the charge amount of the positively charged and negatively charged droplets each is only one value, and the deflection angle is always constant.

Note that the INFINITY satellite is not collected into the main droplet, but moves in a mist form and disorderly adheres to the main droplet to disturb the charge amount, so that the deflection action becomes extremely unstable.

For the above reason, the droplets formed in the microparticle sorting device are desirably the FAST satellites. However, most of the droplets formed by the microparticle sorting device are the SLOW satellites, and conditions under which the FAST satellites are obtained are limited. Parameters that can artificially control droplet formation during operation of the device generally include (a) the flow velocity V (a liquid feeding pressure P), (b) the frequency f, and (c) a piezo actuator vibration amplitude A (an input voltage I). The droplet interval λ (=V/f) can be changed on the basis of (a) and (b), and an effect of the surface tension can be controlled to some extent on the basis of a ratio (λ/d) to the nozzle diameter d. Furthermore, the initial constriction amount can be adjusted with (c). The FAST satellites can be generated when a balance between the initial constriction amount given artificially and the surface tension is set toward the initial constriction amount side.

Furthermore, a typical generation pattern of the FAST satellites is seen in a state where, in a case where foreign matter having a size of about 5 μm is mixed into the discharge nozzle, the jet is inclined in a slightly oblique direction, a length to the nozzle or a break-off point (BOP) is reduced, and an irregular change in droplet shape is present, as illustrated in FIG. 3.

In contrast to the SLOW satellite naturally generated mainly by the action of surface tension as described above, the FAST satellite is a product in a state of being artificially generated under pinpoint conditions or in a state of being irregularly generated, resulting in a problem in stability and reproducibility. Specifically, even if the same droplet formation parameters are used, the FAST satellites do not always appear every time, and there is also a case where a transition is made to the INFINITY satellite and further to the SLOW satellite due to a factor such as a temperature change of a surrounding environment during long-time operation. Furthermore, the nozzle, which is a key part for droplet formation, is attached/detached or replaced on a daily basis at a time of cleaning, but a problem easily occurs in which conditions are not reproduced before and after the attachment/detachment or replacement.

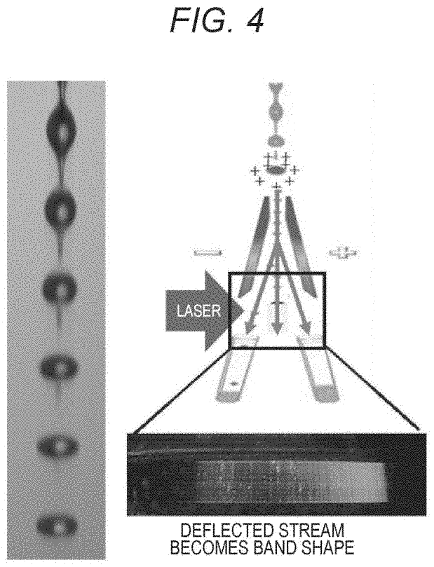

Furthermore, as another problem, while there is a tendency that the FAST satellites are easily obtained by strongly vibrating the piezo with an amplitude amount several times as large as a normal amplitude amount and amplifying the initial constriction amount, there is a case where, as a result, vibration is also transmitted to the nozzle and a device system around the flow path, and the vibration may become noise to amplify temporal variation (jitter) of the droplet cutting timing. When the jitter of the droplets increases, as illustrated in FIG. 4, a deviation in charge timing occurs for each of the droplets, so that a deflection state becomes significantly unstable.

Conventionally, attempts have been made to stably and reproducibly generate the FAST satellites. As an example, U.S. Pat. No. 7,201,875 discloses a technique in which a detachable nozzle is installed with its center intentionally offset by about ±30 μm with respect to an immediately preceding cuvette flow path. It is described that an opportunity to generate the FAST satellites is generated by giving a deviation to a completely axisymmetric flow, which is considered to be a mechanism similar to that at the time when foreign matter is mixed in the nozzle described above. However, in the case of this method, since a position cannot be adjusted after the nozzle is attached to the device, it is not possible to cope with a case where a satellite transition over time occurs during operation. Depending on a use environment of the device, the state of the satellite may change due to a change in temperature and humidity, and thus a method that enables adjustment at any time during operation is desirable.

From the above, in droplet formation of the microparticle sorting device, there is a demand for a method for achieving the FAST satellites in which jitter is not increased, a margin of control parameters is wide, reproducibility is favorable for each operation and at the time of attaching and detaching the nozzle, and stability is maintained over time. At the same time, it is also desirable to be able to track and control a satellite state in real-time during operation.

### 2. First Embodiment (Microparticle Sorting Device 100)

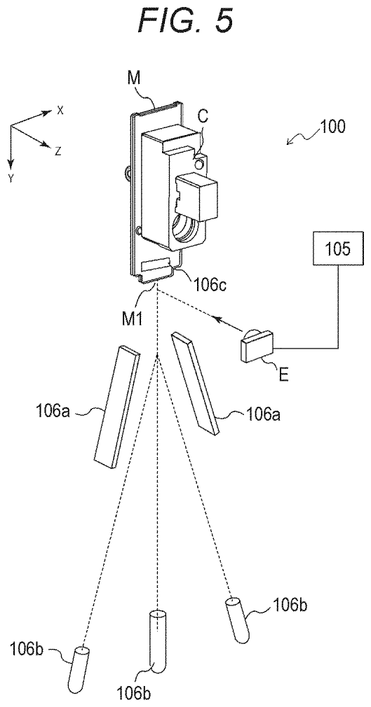

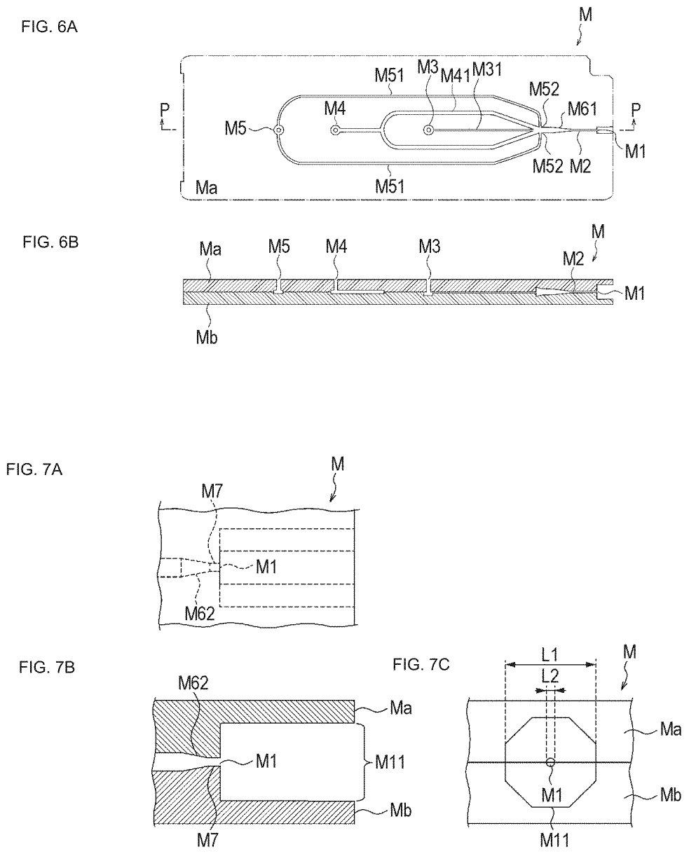

FIG. 5 is a view illustrating a configuration example of a microparticle analysis device 100 according to a first embodiment.

The microparticle sorting device 100 according to the present embodiment includes: an imaging element E configured to acquire an image of fluid and a droplet at a position where liquid discharged from an orifice that generates a stream of the fluid is converted into a droplet; and a processing unit 105 configured to determine a harmonic superposition amplitude ratio, a harmonic phase difference, and a superimposed wave voltage on the basis of states of a satellite droplet and a break-off point in the image.

Each unit will be described in detail below.

(1) Imaging Element E

The imaging element (a camera) E is to image droplets and fluid before being converted into the droplets at a break-off point, which is a position where a laminar flow of sample liquid and sheath liquid discharged from the orifice that generates a stream of the fluid is converted into the droplets. Note that, in addition to an imaging device such as a CCD or a CMOS camera, various imaging elements such as a photoelectric conversion element can be used for imaging the fluid and the droplets.

Furthermore, the imaging element E is preferably provided with a position adjustment mechanism (not illustrated) that is for changing the position of the imaging element E. As a result, the position of the imaging element E can be easily controlled by an instruction of a control unit 110 to be described later. Furthermore, the microparticle sorting device 100 of the present embodiment may be provided with a light source (not illustrated) that illuminates an image capturing region together with the imaging element E.

(2) Processing Unit 105

The processing unit 105 determines a harmonic superposition amplitude ratio, a harmonic phase difference, and a superimposed wave voltage on the basis of states of a satellite droplet and a break-off point in an image acquired by the imaging element E. The processing unit 105 can be configured with an information processing device including, for example, a general-purpose processor, a main storage device, an auxiliary storage device, and the like. In this case, by inputting image data captured by the imaging element E to the processing unit 105, and executing a programmed control algorithm, the harmonic superposition amplitude ratio, the harmonic phase difference, and the superimposed wave voltage can be determined.

The processing unit 105 can be stored as a program in a hardware resource including a recording medium (a non-volatile memory (such as a USB memory), a HDD, a CD, or the like) or the like, and can be caused to function by a personal computer or a CPU. Furthermore, the processing unit 105 may be connected to each unit of the microparticle sorting device 100 via a network.

(3) Flow Path

A flow path allows passage of fluid including a sample flow containing microparticles and a sheath flow flowing so as to enclose the sample flow. This flow path may be provided in advance in the microparticle sorting device 100. However, it is also possible to perform sorting by installing, on the device, a disposable microchip or the like provided with a flow path to be described later. A form of the flow path is not particularly limited, and can be freely designed as appropriate. In the present embodiment, it is particularly preferable to use a flow path formed in a substrate of two-dimensional or three-dimensional plastic, glass, or the like.

A flow path width, a flow path depth, a flow path cross-sectional shape, and the like of the flow path are not particularly limited and can be freely designed, as long as a laminar flow can be formed. For example, a micro flow path having a flow path width of 1 mm or less can also be used for the minute sorting measurement device 100 according to the present embodiment. In particular, a micro flow path having a flow path width of about 10 μm or more and 1 mm or less is suitably used.

(3-1) Microchip M

FIG. 6 is a view illustrating a configuration example of a microchip M, and FIG. 7 is a view illustrating a configuration example of an orifice M1 of the microchip M. A of FIG. 6 is a schematic top view, and B of FIG. 6 is a schematic cross-sectional view corresponding to a P-P cross section in A. Furthermore, A of FIG. 7 is a top view, B of FIG. 7 is a cross-sectional view, and C of FIG. 7 is a front view.

As illustrated in A of FIG. 6, the microchip M is formed with: a sheath liquid flow path M41 that communicates with the main flow path M2 and through which sheath liquid flows; a sheath liquid introduction unit M4 configured to introduce the sheath liquid; a sample liquid flow path M31 that communicates with the main flow path M2 and through which sample liquid containing microparticles flows; a sample liquid introduction unit M3 configured to introduce the sample liquid; and a merging part where the sample flow is introduced and joins with the sheath liquid. The sheath liquid introduced from the sheath liquid introduction unit M4 is fed separately in two directions, and then joins the sample liquid while sandwiching the sample liquid from the two directions, at the merging part between with the sample liquid introduced from the sample liquid introduction unit M3. As a result, a three-dimensional laminar flow in which the sample liquid laminar flow is located at a center of the sheath liquid laminar flow is formed at the merging part.

M51 illustrated in A of FIG. 6 indicates a suction flow path for applying a negative pressure to an inside of the main flow path M2 to temporarily reverse the flow to eliminate clogging and bubbles when clogging or bubbles occur in the main flow path M2. At one end of the suction flow path M51, a suction opening M5 connected to a negative pressure source such as a vacuum pump is formed. Furthermore, another end of the suction flow path M51 is connected to the main flow path M2 at a communication port M52.

A laminar flow width of the three-dimensional laminar flow is narrowed at narrowing parts M61 (see A of FIG. 6) and M62 (see A and B of FIG. 7) formed such that an area of a cross section perpendicular to a liquid feeding direction gradually or stepwisely decreases from upstream to downstream in the liquid feeding direction. Thereafter, the three-dimensional laminar flow is discharged as a stream of the fluid from the orifice M1 provided at one end of the flow path.

In the present embodiment, it is preferable that the stream of the fluid discharged from the orifice M1 is converted into droplets by applying vibration to the sheath liquid flowing through the sheath liquid introduction unit M4, by a sheath liquid converging part C21 to be described later.

The orifice M1 is opened in an end face direction of substrate layers Ma and Mb, and a notch M11 is provided between an opening position thereof and a substrate layer end face. The notch M11 is formed by cutting out the substrate layers Ma and Mb between the opening position of the orifice M1 and the substrate end face such that a diameter L1 of the notch M11 is larger than an opening diameter L2 of the orifice M1 (see C of FIG. 7). The diameter L1 of the notch M11 is preferably formed to be twice or more larger than the opening diameter L2 of the orifice M1 so as not to hinder movement of droplets discharged from the orifice M1.

In the present technology, “micro” means that at least a part of the flow path included in the microchip M has a dimension on the order of μm, particularly, a cross-sectional dimension on the order of μm. That is, in the present technology, the “microchip” refers to a chip including a flow path on the order of μm, particularly a chip including a flow path having a cross-sectional dimension on the order of μm. For example, a chip including a particle sorting unit including a flow path having a cross-sectional dimension on the order of μm may be referred to as the microchip according to the present technology.

The microchip M can be manufactured by a method known in the technical field. For example, the microchip M is formed by bonding the substrate layers Ma and Mb on which the main flow path M2 is formed. The main flow path M2 can be formed in the substrate layers Ma and Mb by, for example, injection molding of a thermoplastic resin with use of a mold. For example, the flow path may be formed in all of the two or more substrates, or may be formed only in some of the two or more substrates. Furthermore, the microchip M may be formed by three or more substrates by further bonding substrates from an upper direction, a lower direction, or both directions with respect to a plane of the substrate in which the individual flow paths are formed.

As a material for forming the microchip M, a material known in the technical field may be used. Examples thereof include, but are not limited to, for example, polycarbonate (PC), cycloolefin polymer, polypropylene, polydimethylsiloxane (PDMS), polymethyl methacrylate (PMMA), polyethylene, polystyrene, glass, silicon, and the like. In particular, a polymer material such as, for example, polycarbonate, cycloolefin polymer, or polypropylene is particularly preferable because it is excellent in processability and a microchip can be manufactured inexpensively using a molding device.

The microchip M is preferably transparent. For example, in the microchip M, at least a portion through which light (laser light and scattered light) passes may be transparent, or the entire microchip M may be transparent.

In the present technology, the “sample” contained in the sample liquid is particularly a microparticle, and the microparticle may be a particle having a dimension that enables flowing in a flow path in the microchip M. In the present technology, the microparticle may be appropriately selected by those skilled in the art. In the present technology, the microparticles may include, for example, biological microparticles such as cells, cell masses, microorganisms, and liposomes, and synthetic microparticles such as gel particles, beads, latex particles, polymer particles, and industrial particles.

The biological microparticles (also referred to as “bioparticles”) may include chromosomes, liposomes, mitochondria, organelles (cell organelles), or the like constituting various cells. The cells may include animal cells (for example, hematopoietic cells or the like) and plant cells. The cells may in particular be blood-derived cells or tissue-derived cells. The blood-derived cells may be, for example, floating cells such as T cells and B cells. The tissue-derived cells may be, for example, adherent cells separated from adherent cultured cells or tissues. The cell masses may include, for example, spheroids, organoids, or the like. The microorganisms may include bacteria such as Escherichia coli, viruses such as tobacco mosaic virus, fungi such as yeast, or the like. Moreover, the biological microparticles may also include biological macromolecules such as nucleic acids, proteins, and composites thereof. These biological macromolecules may be, for example, those extracted from cells, or those contained in blood samples or other liquid samples.

The synthetic microparticles may be, for example, microparticles including an organic or inorganic polymer material, metal, or the like. The organic polymer material may include polystyrene, styrene/divinylbenzene, polymethyl methacrylate, or the like. The inorganic polymer material may include glass, silica, a magnetic material, or the like. The metal may include gold colloid, aluminum, or the like. The synthetic microparticle may be, for example, a gel particle, a bead, or the like, and may be particularly a gel particle or a bead to which one or a combination of two or more selected from an oligonucleotide, a peptide, a protein, and an enzyme is bound.

A shape of the microparticle may be spherical or substantially spherical, or may be non-spherical. A size and a mass of the microparticle may be appropriately selected by those skilled in the art depending on a size of a flow path of the microchip M. On the other hand, the size of the flow path of the microchip M may also be appropriately selected in accordance with the size and the mass of the microparticle. In the present technology, a chemical or biological label, for example, a fluorescent dye, a fluorescent protein, or the like may be attached to the microparticle as necessary. The label may further facilitate detection of the microparticle. The label to be attached may be appropriately selected by those skilled in the art. To the label, a molecule (for example, an antibody, an aptamer, DNA, RNA, or the like) that specifically reacts with the microparticle may bind.

In the present technology, the microparticle is preferably a biological particle, and may be a cell, in particular.

(3-2) Flow Cell

Note that, in the present technology, a similar effect can be obtained even when a flow cell is used instead of the microchip M. In the flow cell, a flow path is formed, and microparticles can be sorted by detecting optical information obtained from the microparticles aligned in a line in the flow path.

The flow cell may be provided in the microparticle sorting device 100 in advance. However, it is also possible to perform sorting by installing a commercially available flow cell or the like on the device.

A form of the flow path formed in the flow cell is also not particularly limited, and can be freely designed. For example, without limiting to the flow path formed in the substrate of two-dimensional or three-dimensional plastic, glass, or the like, a flow path as used in a conventional flow cytometer can be used in the present technology.

(3-3) Connection Member C

The microparticle sorting device 100 according to the present embodiment further includes a connection member attachable to the microchip M and having a sheath liquid introduction coupling part C2 to be coupled to the sheath liquid introduction unit M4.

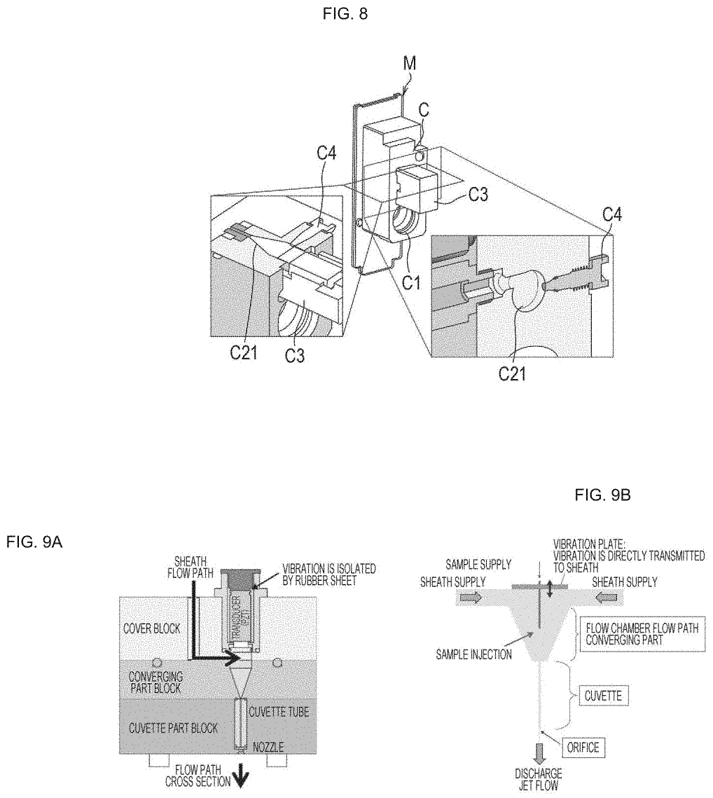

FIG. 8 is a view illustrating a configuration example of the microchip M and a connection member C. The connection member C illustrated in FIG. 8 includes at least a sample introduction coupling part C1 to be coupled to the sample liquid introduction unit M3 and the sheath liquid introduction coupling part C2 to be coupled to the sheath liquid introduction unit M4.

By using the connection member C attachable to and detachable from the microchip M, a part of a component constituting the device can be detached when many different microparticles are continuously sorted using one device. Therefore, even if microparticles contained in a previously sorted fluid flow remain in the component, the entire component can be removed and a risk of contamination can be reduced. Furthermore, by making the microchip M and the connection member C disposable for every sample, it is possible to save time and effort in a cleaning operation performed in changing the sample, and to reduce a burden on an operator.

The sheath liquid introduction coupling part C2 may include a liquid feeding tube capable of feeding liquid from a sheath liquid feeding unit 101. Moreover, the liquid feeding tube may have an inter-tube coupling part to be directly coupled to the sheath liquid feeding unit 101. In this case, the inter-tube coupling part is preferably configured such that liquid in the liquid feeding tube does not come into contact with outside air. This configuration makes it possible to ensure cleanliness of the sheath liquid.

The sample liquid introduction coupling part C1 may have a tube fixing unit to fix the liquid feeding tube capable of feeding liquid from a sample liquid feeding unit 102. As a result, it is possible to save time and effort in attachment, fixing, and the like of each tube, prevent complication of an operation at a time of measurement, and reduce a burden on an operator. Furthermore, by making these members disposable for every sample, contamination can also be prevented.

The liquid feeding tube can be formed integrally with the connection member C, or can be formed separately. For example, the tube fixing unit and the liquid feeding tube capable of feeding liquid from the sample liquid feeding unit 102 are formed detachably from the connection member C, and it is possible to facilitate connection with the sample liquid feeding unit 102 arranged at a place different from the sheath liquid feeding unit 101.

In the present embodiment, a vibration element C3 is attached to the connection member C. As a result, it is possible to propagate vibration to the sheath liquid flowing through the sheath liquid introduction unit M4 of the microchip M, and induce formation of droplets after ejection from the orifice M1.

Furthermore, in the present embodiment, the vibration element C3 is controlled by a vibration application control unit. In the present embodiment, the vibration element C3 and the vibration application control unit are referred to as a “vibration application unit”.

In the present embodiment, the sheath liquid introduction coupling part C2 preferably includes the sheath liquid converging part C21 whose width gradually or partially narrows from a side where the vibration element C3 is attached toward the sheath liquid introduction unit M4 side. As a result, a thickness of the flow path in the sheath liquid introduction coupling part C2 can be gradually narrowed from a thickness of about the vibration element C3 to a thickness of about the sheath liquid introduction unit M4 to connect a scale of a size of the vibration element C3 and a scale of the size of a flow path, vibration energy of the vibration element C3 can be concentrated near the sheath liquid introduction unit M4, and the vibration energy can be efficiently sent into the flow path in the microchip M with a small drive voltage.

Hereinafter, how the vibration is propagated to the sheath liquid near the sheath liquid introduction unit M4 of the microchip M will be described in detail.

The sheath liquid is supplied from the sheath liquid feeding unit 101 to the sheath liquid converging part C21, and the sheath liquid is vibrated by the vibration element C3 arranged upstream of the sheath liquid converging part C21. The vibration element C3 includes, for example, a piezoelectric element part and a piston part, and each is firmly bonded with an adhesive or the like. A structure of the piezoelectric element part is not limited as long as vibration to be finally extracted can be applied with a necessary amplitude at a target vibration application frequency in a desired direction. For example, a structure of a laminated type, a square plate type, a disk type, a tube type, or the like can be considered. Furthermore, a magnetic force such as a permanent magnet and a solenoid may be used as the vibration element C3. Moreover, instead of a structure in which a piston bonded to such a piezoelectric element is inserted into the sheath liquid converging part C21, a structure may be adopted in which a piezoelectric element of a bent type is attached to a top surface of the sheath liquid converging part C21. The sheath liquid is fed into a chip from the sheath liquid introduction unit M4 of the microchip M, and vibration of the vibration element C3 is propagate through the sheath liquid to induce droplet formation after ejection from the orifice M1.

As the vibration element C3, for example, a piezoelectric element such as a piezo element can be used, but a vibration element that converts electric energy into vibration through magnetic force, such as a permanent magnet and a solenoid, can be used as described above. Furthermore, a vibration frequency is not limited to an ultrasonic region of 20 kHz or more, and can be appropriately set according to a size of droplets desired to be formed.

As a material to form the sheath liquid converging part C21, a material known in the technical field can be used. However, it is preferable to form the sheath liquid converging part C21 with a resin, a metal, or a transparent member in the present technology. As the resin, for example, polyether ether ketone (PEEK) or the like can be used. Furthermore, as the transparent member, for example, polymethyl methacrylate (PMMA), polycarbonate (PC), or the like can be used. By forming the sheath liquid converging part C21 with the transparent member, an inside of the sheath liquid converging part 21 can be observed. As the metal, for example, stainless steel, aluminum alloy, titanium alloy, or the like can be used. By forming the sheath liquid converging part C21 with metal, it is possible to omit an electrode for droplet charging.

In a case where the sheath liquid converging part C21 is formed by an insulator such as resin, when an electric charge is applied to formed droplets, the droplets can be charged through the sheath liquid by inserting an electrode C4 into the sheath liquid converging part C21, as illustrated in FIG. 8. The purpose of this is to bring a distance between the droplet dividing point and the electrode C4 as close as possible, and to perform charging at a timing closer to an ideal.

In the present embodiment, the microchip M and the connection member C can be appropriately detached as necessary, and may be disposable. Furthermore, the vibration element C3 attached to the connection member C may also be distributed in a state of being attached to the connection member C in advance, and in this case, the vibration element C3 may be disposable.

(3-4) Modification

A and B of FIG. 9 are views illustrating a configuration example when the present technology is applied in a case where a flow path is formed in a flow cell instead of the microchip M. The sheath liquid and the sample liquid are first injected into a conical container. The cone is installed with an apex directed vertically downward, and a sheath liquid tube is connected to an upper side surface. A container upper surface is open, and the vibration application unit is attached in a state of being sealed with an O-ring. In order to vertically inject cell liquid from above the container, a piezo and a piston have an annular shape, and a pipe passes through a center hole thereof. The sheath liquid converging part C21 has a conical shape and narrows at the bottom, a tip of which is to be coupled to a flow path (a cuvette tube). In this flow path, microparticle inspection by laser irradiation is performed. At an end point of the flow path, an outlet nozzle is installed, and a connection part has a slope shape so as to be continuously narrowed. In the present configuration example, minute vibration is directly applied to the sample liquid at a level of ±several tens nm in a front-back direction with respect to a flow from a piezo actuator unit attached immediately above the conical container.

(4) Verification Example by Simulation

Hereinafter, a verification example by simulation will be described in detail.

In general, the vibration element operates sinusoidally at a desired frequency f. When a sinusoidal wave such as 2f, 3f, 4f, . . . , which is an integral multiple, is superimposed with respect to the frequency f to impart asymmetry to a pushing and pulling operation of the vibration element, it is possible to control SLOW or FAST of a satellite. This is due to an effect of imparting asymmetry in a front-back direction of a flow to an initial constriction and growing the initial constriction into a shape suitable for individual satellite generation immediately before droplet dividing.

When the FAST satellite is generated, a constriction shape immediately before the dividing is distinctive. As illustrated in FIGS. 1 and 3, a droplet part is elongated with respect to the SLOW satellite, has a widest position slightly moved forward in a flow direction, and is connected to a liquid thread so as to draw a tail. A purpose of the present embodiment is to artificially form such a shape.

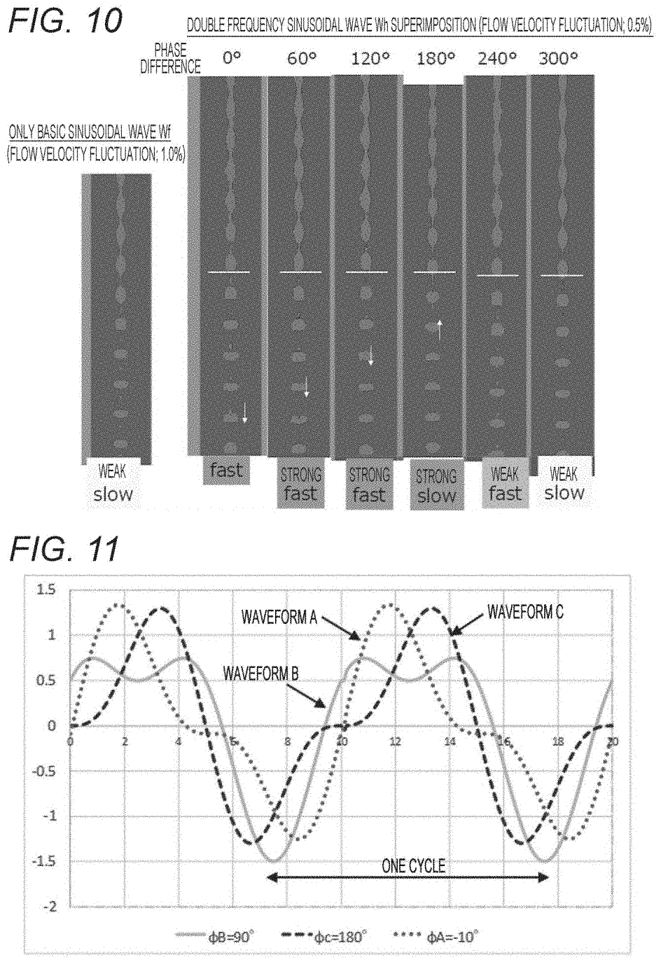

FIG. 10 is a calculation result obtained in a case where a flow velocity fluctuation of 1% at a basic sinusoidal wave frequency f=100 kHz and a flow velocity fluctuation of 0.5% at a double sinusoidal frequency 2f=200 kHz are given to a flow before nozzle discharge, and superimposition is made while a phase difference between the two is rotated by 360°. In this case, a flow velocity after nozzle discharge has been set to V=25.2 m/s. FIG. 10 illustrates a state in which a satellite transitions from SLOW to FAST according to a change in the phase difference, and a state changes from a state close to INFINITY requiring a long cycle until collecting of the satellite after droplet dividing to a state in which the satellite is collected early in two to three cycles. From the result illustrated in FIG. 10, it can be seen that such a state change of the satellite is associated with a shape change in the droplet formation process described above.

As a method of applying the flow velocity fluctuation described above on the device, it suffices that a synthetic wave of a sinusoidal wave having a basic frequency f and a sinusoidal wave (2f, 3f, 4f . . . ) having an integral multiple frequency thereof is used as a drive signal of the vibration element. At that time, it is necessary to adjust an amplitude ratio and a phase difference between the two so that a desired satellite condition can be obtained. However, it should be noted that the drive signal of the vibration element and the actual operation do not necessarily coincide with each other. This is because the amplitude ratio and the phase difference between the basic frequency and the harmonic may not be kept constant depending on frequency characteristics of the vibration element itself and an electric circuit that supplies a signal to the vibration element. In particular, the amplitude rapidly increases near a resonance frequency fr of the vibration application unit, and a phase of a response waveform rapidly changes with respect to an input waveform. When the resonance frequency is shifted due to a factor such as a change in element temperature during operation, there is a possibility that the operation of the vibration application unit is greatly changed. Therefore, in order to realize stable formation of droplets, it is better to avoid the use near the resonance frequency fr. Specifically, it is preferable to select one type of a frequency fh of a harmonic separated from the resonance frequency fr of the vibration element C3 by ±10 kHz or more.

This is the reason for using a harmonic sinusoidal wave having a known frequency instead of using a rectangular wave or a sawtooth wave in the present embodiment. It is possible to generate the FAST satellites even in a case where the piezo is driven by a rectangular wave or a sawtooth wave. However, each has a plurality of high-order components such as twice, three times, four times, and five times, and there may be a case where any frequency approaches the resonance frequency of the vibration application unit, so that stability over time is often insufficient.

For the above reasons, according to characteristics of the vibration application unit to be used, use at frequencies that cause a phase change (for example, Δθ≥[10°/10 kHz]) equal to or greater than a reference value is avoided, and use of frequencies having mutually different positive/negative directions of the phase change is particularly prohibited. Furthermore, for the selection of the harmonic, it is preferable to use a wave that is farthest from the resonance frequency fr among a second harmonic, a third harmonic, and a fourth harmonic . . . . In practice, as the frequency is higher order, a vibration amplitude decreases from a characteristic upper limit of a vibration element driving electric circuit, and sufficient satellite control can no longer be obtained. Therefore, the frequency at which the vibration amplitude becomes 50% or less with respect to the basic wave amplitude is out of options in advance. Therefore, it is considered practical to use up to the second, third, and fourth harmonics.

From the above, it is necessary to select the vibration element in consideration of the operation at the basic frequency assumed to be used and the frequencies twice and three times the basic frequency, design a piston weight and the like such that the resonance frequency fr does not approach the harmonic as a whole of the vibration application unit, and measure and grasp the frequency characteristics after completion. If possible, it is desirable that the amplitudes and phases of the basic wave and the harmonic coincide with each other, and there is no difference between a piezo drive signal and the actual operation of the vibration application unit.

In order to make a transition from a state in which the SLOW satellites are generated by sinusoidal wave driving to the FAST satellites, as the operation of the vibration application control unit in the vibration application unit, it is preferable to distort a sinusoidal movement and to cause an operation to make a displacement waveform of the vibration element C3 to be asymmetric in a time axis direction between the pushing operation and the pulling operation. As a specific example, three types of waveforms are illustrated in FIG. 11.

Here, a waveform A is a sinusoidal wave of the frequency f+a sinusoidal wave of the frequency 2f, with an amplitude ratio 2:1, a phase difference φ=−10 degrees, λ=sin (2πf)t+0.5×sin (4πf+φA)t, and φA=−10 degrees,

a waveform B is a sinusoidal wave of the frequency f+a sinusoidal wave of the frequency 2f, with an amplitude ratio 2:1, a phase difference φ=90 degrees, B=sin (2πf)t+0.5×sin (4πf+φB)t, and φB=90 degrees, and

a waveform C is a sinusoidal wave of the frequency f+a sinusoidal wave of the frequency 2f, with an amplitude ratio 2:1, a phase difference φ=180 degrees, C=sin (2πf)t+0.5×sin (4πf+φC)t, and φc=180 degrees.

In the waveform A, a rising speed toward a positive side (a pushing side) is faster than a falling speed toward a negative side (a pulling side). The waveform B is a waveform in which a recess is generated on the way and the rising speed and the falling speed are equal, and is symmetrical in the time axis direction. The waveform C is a waveform obtained by inverting the waveform A in the time axis direction, and the falling speed to the negative side (the pulling side) is faster than the rising speed to the positive side (the pushing side).

First, it has been found that a drive waveform symmetrical in the time axis direction as in the waveform B is not suitable for use because there is a strong tendency to involve extension of a BOP length and increase droplet jitter. This similarly applies to a signal in which positive and negative are inverted obtained by further advancing the phase difference by 180°. This is considered to be a result of overall instability due to a conflict between perturbation of the frequency 2f and a surface tension as the surface tension cannot develop constrictions since “λ′≥n×d” described above is not satisfied for the droplet interval λ′=V/2f of the frequency 2f, even though a state is established in which droplets can be formed even at the double frequency 2f in addition to the basic frequency f. In such a phase difference φs, even if the amplitude ratio between the basic wave and the second harmonic is changed, the symmetry in the time axis direction is maintained. Therefore, it is desirable not to use a phase within ±100 from φs.

In the present embodiment, it is preferable to form the FAST satellite that is particularly quickly collected, and the operation of the vibration application unit asymmetric in the time axis direction such as the waveform A and the waveform C is suitable. However, what type of superimposed waveform is optimum is different depending on a device configuration and main droplet forming conditions such as a frequency, a nozzle diameter, and a flow velocity, and is difficult to be predicted. Therefore, it is important to determine the basic wave and a harmonic superposition amplitude ratio, a harmonic phase difference, and a superimposed wave voltage, and to be able to easily perform these adjustments on the device immediately before measurement.

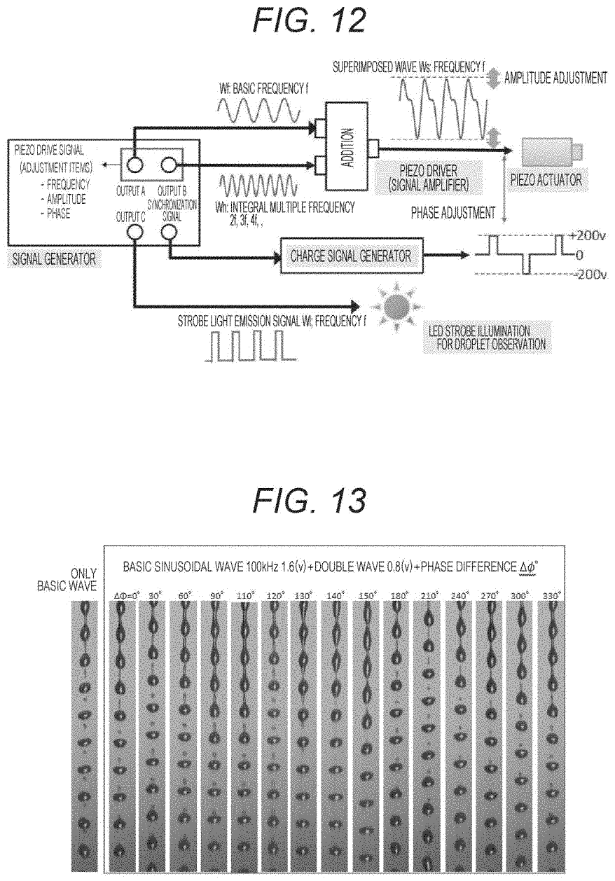

An actual configuration example of a signal generation unit in consideration of the above points will be described below (see FIG. 12).

A signal generator supplies outputs of the following three systems synchronized with each other and a synchronization signal for timing adjustment with a charge signal to a charge signal generation unit.

(a) Output A: For Piezo Drive

Basic sinusoidal wave Wf: a sinusoidal wave having a frequency f is outputted. A voltage is adjusted.

(b) Output B: For Piezo Drive (Harmonic Sinusoidal Wave Wh)

A harmonic of a frequency 2f, 3f, 4f . . . is outputted. A voltage and a phase are adjusted.

(c) Output C: Illumination for Droplet Observation (Strobe Light Emission Signal Wl)

LED illumination is turned ON/OFF at the basic frequency f in synchronization with the piezo drive signal, and droplets are observed in a stationary state. Furthermore, when phase adjustment is performed on Wf, observation can be performed at any time within one droplet cycle.

(d) Output D: Charging Synchronization Signal

Droplet formation and charging require strict timing adjustment. A charge signal generator may be separately prepared, but it is necessary to supply a synchronization signal so that phase adjustment can be performed with the droplet formation and charging being synchronized.

The piezo drive signals of (a) and (b) are superimposed on a dedicated piezo driver having a sufficient current supply capability, and are outputted to the piezo element as a superimposed wave Ws after amplification. The piezo driver is provided with an output voltage variable function of the superimposed waveform Ws, to enable BOP fine adjustment described later.

(5) Each Parameter Determination Procedure on Device

Hereinafter, each parameter determination procedure on the device will be described in detail.

<Before Measurement>

[1] Setting of Sheath Liquid Flow Velocity V

A flow velocity of the sheath liquid injected from a pressurized tank into the device is adjusted by pressure of a pressurizing air compressor. In a case where a pressure loss in the device is sufficiently small, a reference of a pressure value P is “P=½×ρ×V²” with respect to the flow velocity V after nozzle discharge. (ρ; a sheath liquid density) The flow velocity V is basically set to “V/f=4.5×d” with respect to a desired droplet frequency f according to the above-described Rayleigh theory. However, since a satellite transition between SLOW and FAST becomes easier when the droplet interval is narrower, the flow velocity may be reduced to about “V/f=4.0×d” in a situation where generation of the FAST satellites is difficult.

[2] Coarse Adjustment of Basic Sinusoidal Wave Wf

From the signal generator output A, the sinusoidal wave Wf of the frequency f is outputted to the piezo actuator via the piezo driver. A voltage of the sinusoidal wave is adjusted so that a reference BOP length can be obtained.

[3] Superimposition of Harmonic Wh

A sinusoidal wave of a harmonic Wh of the frequency fh (an integral multiple of f), which is more distant from the resonance frequency fr of the vibration application unit, is outputted from the signal generator output B and superimposed on the basic wave on the piezo driver.

[4] Determination of Superimposing Condition of Basic Sinusoidal Wave Wf and Harmonic Wh

After the basic sinusoidal wave Wf is fixed, a voltage and a phase of the harmonic Wh are determined, and a harmonic superposition amplitude ratio R (=Wh/Wf) and a harmonic phase difference Δφ of the two are optimized.

[Step 1: Determination of Harmonic Superposition Amplitude Ratio R]

For the harmonic superposition amplitude ratio R (Wh/Wf), a solution is often found in a range of 0.1 to 1.0. As R increases, a satellite fluctuation between SLOW and FAST according to the harmonic phase difference Δφ also increases. However, at the same time, BOP expansion and contraction also increase due to a slight change in Δφ, control becomes difficult, and there is a tendency for jitter to increase. Conversely, when R is equal to or less than a required amount, there is a case where the transition from the SLOW satellite to the FAST satellite cannot be completed. Therefore, it is necessary to set an appropriate R value first.

Therefore, the harmonic phase difference Δφ is fixed to an intermediate value of R=0.5 first, and made to go one round from 0° to 360°, and states of droplets and satellites are observed. Here, if the FAST satellite can be found, R is lowered to 0.4 and the similar operation is performed. Conversely, if the FAST satellite cannot be found, R is increased to 0.6 and the state is observed. While searching for R in this manner, it is preferable to obtain an upper limit value of R at which no jitter occurs visually in a droplet observation image and a lower limit value of R at which the FAST satellite is generated, and set R in the middle thereof.

[Step 2: Determination of Harmonic Phase Difference Δφ]

The harmonic superposition amplitude ratio R value obtained in Step 1 is fixed, and the harmonic phase difference Δφ is determined. Also in this case, Δφ is obtained at which a desired FAST satellite is obtained, while droplets are being observed. At that time, it is desirable to avoid a point of rapid transition from the FAST satellite toward the SLOW satellite side with respect to a phase change, and to set Δφ at which a satellite fluctuation is minimized in order to maintain temporal stability after a start of measurement.

Here, an example of a satellite and a BOP length fluctuation in a case where Δφ is changed by 360° will be described.

The basic frequency f was set to 100 kHz, the harmonic frequency fh was set to 200 kHz, and the amplitude ratio R was set to 0.5. Furthermore, the nozzle diameter d was 70 μm, and the liquid feeding system pressure P was set to 550 kPa. At this time, the flow velocity V was 28 m/s.

FIG. 13 is a droplet observation image in a case of only the basic wave Wf and in a case of changing the harmonic Wh at the phase difference Δφ=0 to 360°. A SLOW satellite state is obtained in the case of only the basic wave Wf, but a transition is made to the FAST satellite except for the phase difference Δφ=130 to 1400 when Wh is superimposed.

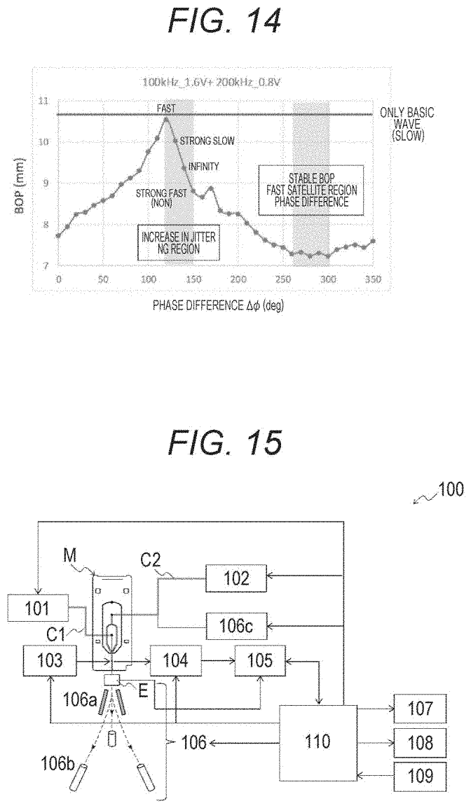

FIG. 14 is a graph illustrating a change in BOP length associated with the harmonic phase difference Δφ. When the harmonic phase difference Δφ is in a range of 2600 to 300°, a BOP fluctuation is almost zero. Therefore, when Δφ=2800 in the middle is set, the most stable state is obtained. Whereas, when the harmonic phase difference Δφ is in a range of 0 to 1000 and 200 to 250°, the FAST satellite is obtained, but the BOP length change associated with the phase difference fluctuation is also large, and thus it is better to avoid use from the viewpoint of long-term stability.

Note that, while the present example is a case of R=0.5, there is a strong unstable region in which a BOP length fluctuation width is 4 mm or more due to the phase difference change, and in particular, the droplet jitter increases in a range of Δφ of 1200 to 150°. This is because R is too large, and R needs to be lowered to an appropriate value by the method described above.

[5] Fine Adjustment of BOP (Determination of Superimposed Wave Voltage Vs)

After droplets are formed by the superimposed wave Ws, a BOP fluctuation occurs for droplets formed only by the basic wave Wf of [2] described above. If necessary, a voltage of the piezo driver is adjusted, and the superimposed wave Ws output voltage Vs is determined so as to have a desired BOP value while a waveform of the superimposed wave Ws determined in [4] described above is maintained.

<During Measurement>

After the start of the measurement, the droplet BOP may fluctuate from a state before the measurement due to factors such as actual start of flowing of the microparticles or a change in temperature and humidity around the device. Moreover, there is a case where the satellite transitions to the SLOW side, and a normal deflection action cannot be maintained. At that time, it is necessary to perform the following readjustment.

[6] Fine Adjustment of BOP (Fine Adjustment of Superimposed Wave Voltage Vs)

While a BOP fluctuation of about several tens of microns can easily occur, a deviation from a droplet charging timing in the deflection occurs, which causes a change in deflection angle and a situation in which droplets before and after a target droplet are erroneously deflected in some cases. Therefore, adjustment is required as needed so that the BOP is maintained within ±10 μm. While droplets near the BOP are monitored, the superimposed wave Ws output voltage Vs is finely adjusted in the same procedure as in [5] described above so that a BOP position maintains an initial position. This work can be desirably always automatically processed without interrupting the measurement.

[7] Readjustment of Superimposing Condition of Basic Sinusoidal Wave Wf and Harmonic Wh

When the satellite can no longer maintain the FAST satellite and transitions to the INFINITY satellite, the harmonic phase difference Δφ between the basic wave Wf and the harmonic Wh is adjusted again. Furthermore, the harmonic superposition amplitude ratio R may also need to be readjusted. In a case where the FAST satellite is not generated even if the harmonic phase difference Δφ is adjusted, R is preferably increased by increasing the amplitude of the harmonic Wh. Furthermore, in a case where dispersion of the deflection angle is expanded from the beginning or becomes a band shape, there is a possibility that the droplet jitter is slightly increased at a visible level or lower. In such a situation, lowering the amplitude of the harmonic Wh may allow improvement. In a case where this adjustment is performed, the BOP position fluctuates, and thus the BOP adjustment operation [6] described above is also required.

### 3. Second Embodiment (Microparticle Sorting Device 100)

FIG. 15 is a diagram illustrating a configuration example of a microparticle sorting device according to a second embodiment.

A microparticle sorting device 100 according to the present embodiment includes: a light irradiation unit 103 configured to irradiate a microparticle with light; a light detection unit 104 configured to detect light from the microparticle; an imaging element E configured to acquire an image of fluid and a droplet at a position where liquid discharged from an orifice that generates a stream of the fluid is converted into a droplet; and a processing unit 105 configured to determine a harmonic superposition amplitude ratio, a harmonic phase difference, and a superimposed wave voltage on the basis of states of a satellite droplet and a break-off point in the image. Furthermore, a droplet formation unit, a sorting unit 106, a storage unit 107, a display unit 108, an input unit 109, a control unit 110, and the like may be provided as necessary.

Since the imaging element E and the processing unit 105 are similar to those described above, a description thereof is omitted here.

(1) Light Irradiation Unit 103

The light irradiation unit 103 irradiates a microparticle to be sorted with light (for example, excitation light or the like). The light irradiation unit 103 may include a light source that emits light and an objective lens that condenses excitation light on the microparticle flowing in a detection region. The light source may be appropriately selected by those skilled in the art in accordance with a purpose of sorting, and may be, for example, a laser diode, an SHG laser, a solid-state laser, a gas laser, or a high-intensity LED, or a combination of two or more thereof. The light irradiation unit 103 may include other optical elements as necessary in addition to the light source and the objective lens.

(2) Light Detection Unit 104

The light detection unit 104 detects scattered light and/or fluorescence generated from the microparticles by irradiation with the light irradiation unit 103. The light detection unit 104 may include a condenser lens that condenses fluorescence and/or scattered light generated from the microparticle, and a photodetector. As the photodetector, a PMT, a photodiode, a CCD, a CMOS, or the like may be used, but the photodetector is not limited thereto in the present technology. The light detection unit 104 may include other optical elements as necessary in addition to the condenser lens and the photodetector. The light detection unit 104 may further include, for example, a spectroscopic unit. Examples of an optical component constituting the spectroscopic unit include, for example, a grating, a prism, and an optical filter. The spectroscopic unit can detect, for example, light having a wavelength that should be detected separately from light having other wavelength.

The fluorescence detected by the light detection unit 104 may be fluorescence generated from the microparticle itself and fluorescence generated from a substance labeled in the microparticle, for example, a fluorescent substance or the like, but is not limited in the present technology. The scattered light detected by the light detection unit 104 may be forward scattered light, side scattered light, Rayleigh scattering, Mie scattering, or a combination thereof.

(3) Droplet Formation Unit

The droplet formation unit applies vibration to fluid by using a vibration element C3, to form droplets in the fluid. The vibration element C3 is preferably provided so as to be in contact with the flow path, and more preferably provided near a fluid discharge port of the flow path. In particular, in a case where a microchip 2 is used, the vibration element C3 is preferably provided near an orifice 21 of the microchip 2 described above. In the present embodiment, the vibration element C3 is controlled by a vibration application control unit. Since the vibration element C3 is similar to that described above, a description thereof is omitted here.

(4) Sorting Unit 106 (Including Charging Unit 106c)

The sorting unit 106 includes at least a deflection plate 106a configured to change charged droplets in a desired direction and an accumulation container 106b (for example, a cylindrical container having a diameter of 5 mm, or the like) that accumulates droplets. Although separately defined in FIG. 15, a charging unit 106c is a part of the sorting unit 106, and performs charging on the basis of a sorting control signal generated by the processing unit 105.

In the microparticle sorting device 100 illustrated in FIG. 15, the vibration element C3 attached to a connection member C forms droplets by propagating vibration to the sheath liquid as described above. The charging unit 106c is connected to an electrode C4 inserted into the sheath liquid converging part C21 described above, and charges droplets discharged from the orifice M1 of the microchip M positively or negatively on the basis of a sorting control signal generated by the processing unit 105. In a case where the microchip M is used, an electric charge is applied to droplets discharged from the orifice 21 formed in the microchip M. For example, as illustrated in FIG. 15, the charging unit 106c is arranged upstream of the imaging element E. Then, the charged droplet, whose path is changed to a desired direction by the deflection plate (counter electrode) 106a, is applied with the voltage, and is sorted.

(5) Storage Unit 107

The storage unit 107 stores all items related to measurement such as a value detected by the light detection unit 103, a feature amount calculated by the processing unit 105, a sorting control signal, and a sorting condition inputted by the input unit.

In the microparticle sorting device 100, the storage unit 107 is not essential, and an external storage device may be connected. As the storage unit 107, for example, a hard disk or the like can be used. Furthermore, the recording unit 107 may be connected to each unit of the microparticle sorting device 100 via a network.

(6) Display Unit 108

The display unit 108 can display all items related to measurement such as a value detected by the light detection unit 103 and a feature amount calculated by the processing unit 105. Preferably, the display unit 108 displays, as a scattergram, a feature amount for each microparticle calculated by the processing unit 105.

In the microparticle sorting device 100, the display unit 108 is not essential, and an external display device may be connected. As the display unit 110, for example, a display, a printer, or the like can be used. Furthermore, the display unit 108 may be connected to each unit of the microparticle sorting device 100 via a network.

(7) Input Unit 109

The input unit 109 is a portion to be operated by a user such as an operator. The user can access the control unit 110 described later through the input unit 109, to control each unit of the microparticle sorting device 100. The input unit 109 preferably sets a region of interest on the scattergram displayed on the display unit 108, and determines a sorting condition.

In the microparticle sorting device 100, the input unit 109 is not essential, and an external operation device may be connected. As the input unit 109, for example, a mouse, a keyboard, or the like can be used. Furthermore, the input unit 109 may be connected to each unit of the microparticle sorting device 100 via a network.

(8) Control Unit 110

The control unit 110 is configured to be able to control each of the light irradiation unit 103, the light detection unit 104, the analysis unit 105, the sorting unit 106, the charging unit 106c, the recording unit 107, the display unit 108, and the input unit 109. The control unit 110 may be arranged separately for each unit of the microparticle sorting device 100, or may be provided outside the microparticle sorting device 100. For example, the control unit 110 may be implemented by a personal computer or a CPU, and further, the control unit 110 can be stored as a program in a hardware resource including a recording medium (a non-volatile memory (such as a USB memory), a HDD, a CD, or the like) or the like, and can be caused to function by the personal computer or the CPU. Furthermore, the control unit 110 may be connected to each unit of the microparticle sorting device 100 via a network.

### 4. Third Embodiment (Microparticle Sorting System)

A microparticle sorting system according to the present embodiment includes: an imaging device configured to acquire an image of fluid and a droplet at a position where liquid discharged from an orifice that generates a stream of the fluid is converted into a droplet; and a processing device configured to determine a harmonic superposition amplitude ratio, a harmonic phase difference, and a superimposed wave voltage on the basis of states of a satellite droplet and a break-off point in the image.

Since a method performed in the imaging device is the same as the method performed in the imaging element E described above, a description thereof is omitted here. Furthermore, since a method performed in the processing device is the same as the method performed in the processing unit 105 described above, a description thereof is omitted here.

### 5. Fourth Embodiment (Microparticle Sorting Method)

A microparticle sorting method according to the present embodiment includes: an imaging step of acquiring an image of fluid and a droplet at a position where liquid discharged from an orifice that generates a stream of the fluid is converted into a droplet; and a processing step of determining a harmonic superposition amplitude ratio, a harmonic phase difference, and a superimposed wave voltage on the basis of states of a satellite droplet and a break-off point in the image.

Since a method performed in the imaging step is the same as the method performed in the imaging element E described above, a description thereof is omitted here. Furthermore, since a method performed in the processing step is the same as the method performed in the processing unit 105 described above, a description thereof is omitted here.

### (1) Flow Example 1

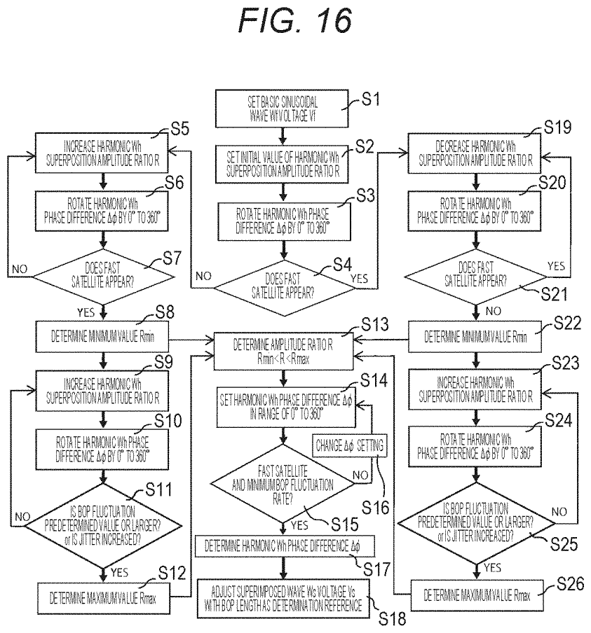

A flow of the microparticle sorting method according to the present technology will be described with reference to FIG. 16.

The flow illustrated in FIG. 16 is most reliable in a case where there is a change in basic frequency f and flow velocity V, or in a case where there is a possibility of a large state change after nozzle replacement, when adjustment is started from zero without any reference of a superimposed waveform.

Note that a harmonic frequency fh (a second harmonic, a third harmonic, or the like) is selected in advance on the basis of characteristics of a piezo actuator.

First, a voltage Vf in a basic sinusoidal wave Wf is set (S1). Next, an initial value of a harmonic superposition amplitude ratio R is set (S2). Next, a harmonic Wh phase difference Δφ is made to go one round from 0° to 360°, and states of droplets and satellites are observed (S3).

Here, if the FAST satellite does not appear (S4), a set value of the harmonic superposition amplitude ratio R is increased (S5), then a harmonic phase difference Δφ is made to go one round from 0° to 360°, and states of droplets and satellites are observed (S6). Here, if the FAST satellite does not appear (S7), the process returns to S5.

Whereas, when the FAST satellite appears (S4), a set value of the harmonic Wh superposition amplitude ratio R is decreased (S19), then the harmonic Wh phase difference Δφ is made to go one round from 0° to 360°, and states of droplets and satellites are observed (S20). Here, when the FAST satellite appears (S21), the process returns to S19.

When the FAST satellite appears in S7 or the FAST satellite has not appeared in S21, a minimum value Rmin of the harmonic superposition amplitude ratio R is determined (S8, S22). Next, a set value of the harmonic superposition amplitude ratio R is increased (S9, S23), then the harmonic phase difference Δφ is made to go one round from 0° to 360°, and states of droplets and satellites are observed (S10, S24). Here, if a fluctuation of the BOP is not equal to or larger than a predetermined value, or if an increase in jitter is not recognized (S11, S25), the process returns to S9 or S23.

Whereas, when the fluctuation of the BOP is equal to or larger than the predetermined value or an increase in jitter is recognized (S11, S25), a maximum value Rmax of the harmonic superposition amplitude ratio R is determined (S12, S26). When the minimum value Rmin and the maximum value Rmax of R are determined from the steps above, R is determined to be an intermediate value (S13). Next, the harmonic phase difference Δφ is adjusted (S14), and a value at which the FAST satellite appears and the BOP fluctuation rate is minimized with respect to the phase change is searched. If the value is not found (S15), the setting of Δφ is changed (S16), and the process returns to S14.

Whereas, when the value is found at which the FAST satellite appears and the BOP fluctuation rate is minimized with respect to the phase change (S15), the harmonic phase difference Δφ is determined (S17). Next, an output voltage Vs of a superimposed wave Ws is adjusted by using a BOP length as a determination reference (S18).

### (2) Flow Example 2

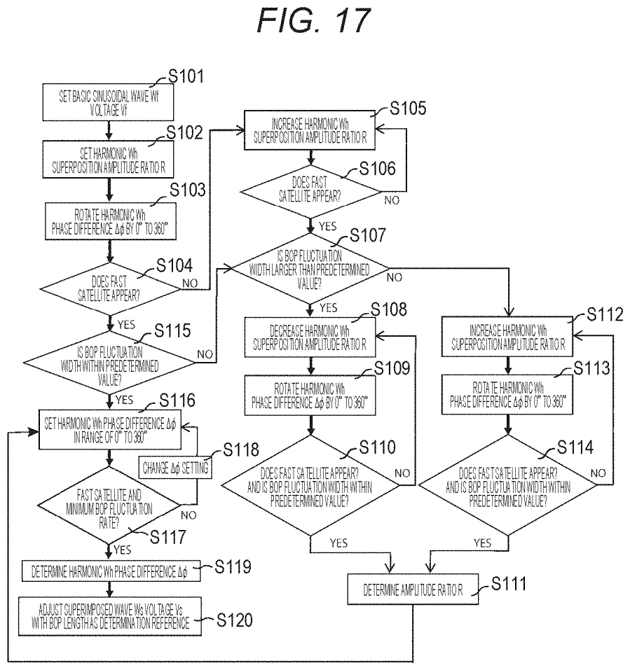

A flow of the microparticle sorting method according to the present technology different from the flow illustrated in FIG. 16 will be described with reference to FIG. 17.

The flow illustrated in FIG. 17 achieves shortening of a condition setting time in a case where it is expected that there is no change in measurement condition or no large change in device state, such as a case of restart after measurement interruption. However, if reproducibility of droplets is poor for some reason and a solution that simultaneously satisfies a FAST satellite generation condition and a BOP fluctuation width condition is not found in the flow illustrated in FIG. 17, the process may return to the flow illustrated in FIG. 16.

Note that the harmonic frequency fh (a second harmonic, a third harmonic, or the like) is selected in advance on the basis of characteristics of the piezo actuator.

First, the voltage Vf in the basic sinusoidal wave Wf is set (S101). Next, a conventional value is adopted and set as a value of the harmonic superposition amplitude ratio R (S102). Next, the harmonic phase difference Δφ is made to go one round from 0° to 360°, and states of droplets and satellites are observed (S103).

Here, when the FAST satellite appears (S104), it is determined as allowable when the BOP fluctuation width is within a range of a BOP fluctuation width that is associated with a phase change and is determined in advance as a reference of reproducibility (for example, 2.0±0.5 mm, or the like) (S115). As a result, after the value of R is determined, the harmonic phase difference Δφ is adjusted (S116), and a value at which the FAST satellite appears and the BOP fluctuation rate is minimized with respect to the phase change is searched. If the value is not found (S117), the setting of Δφ is changed (S118), and the process returns to S116. Whereas, when the value is found at which the FAST satellite appears and the BOP fluctuation rate is minimized with respect to the phase change (S117), the harmonic phase difference Δφ is determined (S119). Next, the output voltage Vs of the superimposed wave Ws is adjusted by using a BOP length as a determination reference (S120).

If the FAST satellite has not appeared in S104 (S104), a set value of the harmonic superposition amplitude ratio R is increased (S105), and then a state of satellites is observed (S106). Here, if the FAST satellite does not appear (S106), the process returns to S105. When the FAST satellite appears (S106), it is checked whether or not a BOP fluctuation width is larger than a predetermined value (S107). If the BOP fluctuation width is not larger than the predetermined value (S107), a set value of the harmonic superposition amplitude ratio R is increased (S112), then the harmonic phase difference Δφ is made to go one round from 0° to 360°, and states of droplets and satellites are observed (S113). Here, a value at which the FAST satellite appears and the BOP fluctuation rate is minimized with respect to the phase change is searched, and the process returns to S112 if the value is not found (S114). Whereas, when the value is found at which the FAST satellite appears and the BOP fluctuation rate is minimized with respect to the phase change (S114), the value of R is determined (S111). After the value of R is determined, the process proceeds to S116.

When the BOP fluctuation width is larger than the predetermined value in S107 (S107), a set value of the harmonic superposition amplitude ratio R is decreased (S108), then the harmonic phase difference Δφ is made to go one round from 0° to 360°, and states of droplets and satellites are observed (S109). Here, a value at which the FAST satellite appears and the BOP fluctuation rate is minimized with respect to the phase change is searched, and the process returns to S108 if the value is not found (S110). Whereas, when the value is found at which the FAST satellite appears and the BOP fluctuation rate is minimized with respect to the phase change (S110), the value of R is determined (S111). After the value of R is determined, the process proceeds to S116.

Furthermore, when the BOP fluctuation width is out of the predetermined range in S115 (S115), the process proceeds to S107.

### (3) Flow Example 3

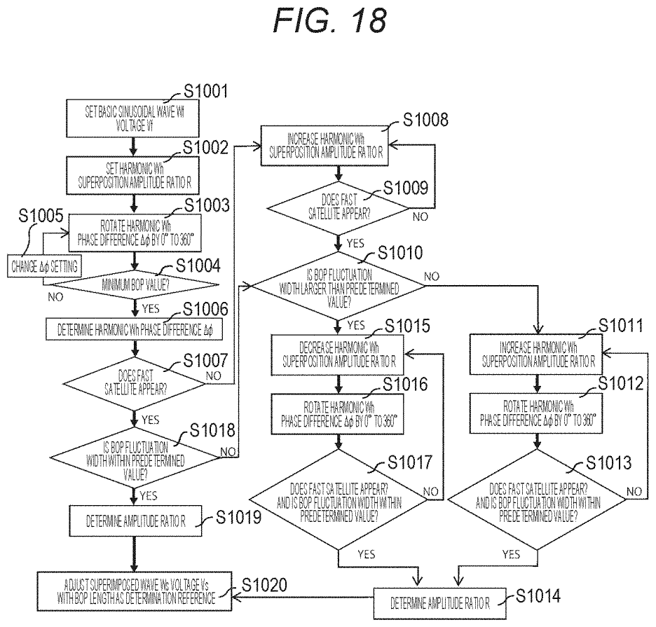

A flow of the microparticle sorting method according to the present technology different from the flows illustrated in FIGS. 16 and 17 will be described with reference to FIG. 18.

In the flow illustrated in FIG. 18, as illustrated in FIG. 14, there is a strong tendency that, at a point where the BOP length becomes the shortest with respect to Δφ, the FAST satellite is generated and the BOP length is stabilized with respect to a change in the harmonic phase difference Δφ. Therefore, a method is conceivable in which, at an appropriate amplitude ratio R, Δφ is rotated by 360° first and Δφ is determined at an angle at which BOP becomes the shortest.

Note that the harmonic frequency fh (a second harmonic, a third harmonic, or the like) is selected in advance on the basis of characteristics of the piezo actuator.

First, the voltage Vf in the basic sinusoidal wave Wf is set (S1001). Next, a conventional value is adopted and set as a value of the harmonic superposition amplitude ratio R (S1002). If the initial harmonic superposition amplitude ratio R is a known value conventionally used under the same condition, there is a high possibility that the harmonic superposition amplitude ratio R can be used as it is. Next, the harmonic phase difference Δφ is made to go one round from 0° to 360°, and states of droplets and satellites are observed (S1006). Here, when the BOP value is not the minimum (S1004), the setting of Δφ is changed (S1005), and the process returns to S1003.

Whereas, when the BOP value is the minimum (S1004), the harmonic phase difference Δφ is determined (S1006). Here, when the FAST satellite appears (S1007), and when a BOP fluctuation width falls within a predetermined range (S1018), the harmonic superposition amplitude ratio R is determined (S1019). After the determination of Δφ and R, the output voltage Vs of the superimposed wave Ws is adjusted similarly to that in the flow illustrated in FIG. 16 (S1020)

If the FAST satellite has not appeared in S1007, a set value of the harmonic superposition amplitude ratio R is increased (S1008), and then a state of satellites is observed (S1009). Here, if the FAST satellite has not appeared (S1009), the process returns to S1008. When the FAST satellite appears (S1009), when the BOP fluctuation width is larger than a predetermined value (S1010), a set value of the harmonic superposition amplitude ratio R is decreased (S1015), then the harmonic phase difference Δφ is made to go one round from 0° to 360°, and states of droplets and satellites are observed (S1016). Here, when the FAST satellite appears and the BOP fluctuation width is within the predetermined value (S1017), the harmonic superposition amplitude ratio R is determined (S1014). After the value of R is determined, the process proceeds to S1020. Whereas, if the FAST satellite has not appeared or the BOP fluctuation width is not within the predetermined value (S1017), the process returns to S1015.

If the BOP fluctuation width is not larger than the predetermined value in S1010 (S1010), a set value of the harmonic superposition amplitude ratio R is increased (S1011), then the harmonic phase difference Δφ is made to go one round from 0° to 360°, and states of droplets and satellites are observed (S1012). Here, when the FAST satellite appears and the BOP fluctuation width is within the predetermined value (S1013), the harmonic superposition amplitude ratio R is determined (S1014). After the value of R is determined, the process proceeds to S1020. Whereas, if the FAST satellite has not appeared or the BOP fluctuation width is not within the predetermined value (S1013), the process returns to S1011.

Furthermore, when the BOP fluctuation width is out of the predetermined range in S1018 (S1018), the process proceeds to S1010.

### (4) Other

In the present embodiment, it is desirable that all the processes of each flow example described above are programmed and automatically executed. In particular, since each procedure includes several times of a process of rotating the harmonic phase difference Δφ by 360°, observing a behavior of droplets and satellites, and obtaining the BOP length, this process dominates the entire time. Therefore, it is required to shorten the time as much as possible.

Therefore, a method for automatically rotating a harmonic phase difference in a short time is proposed below.

When superimposition is performed with the harmonic frequency fh set to a value obtained by adding a minute amount Δf to an original value (fh=2f, 3f, 4f . . . ) with respect to the frequency f of the basic wave, a waveform change equal to one round 360° rotation of Δφ is executed with time T=1/Δf. For example, in a case where f is set to 100 kHz and fh is set to 200.0001 kHz (=200 kHz+0.1 Hz), the 360° rotation operation of the phase difference Δφ is completed in T=10 seconds. Since a phase change occurs continuously in an analog manner, there is no missing of data, and it is possible to know a more accurate behavior change of droplets, as compared with a case of observing at 10° step, for example. Furthermore, when manual adjustment is performed, it is possible for the user to determine presence or absence of the FAST satellite generation, a fluctuation width of the BOP length, and an occurrence of jitter in a very short time from a droplet observation image, and the above-described adjustment procedure is shortened.

### EXAMPLES

Hereinafter, the present invention will be described in more detail on the basis of examples.

Note that the examples described below are examples of representative examples of the present invention, and do not cause the scope of the present invention to be narrowly interpreted.

<Relationship Between Piezo Element Frequency Characteristics and Piezo Actuator Operation>

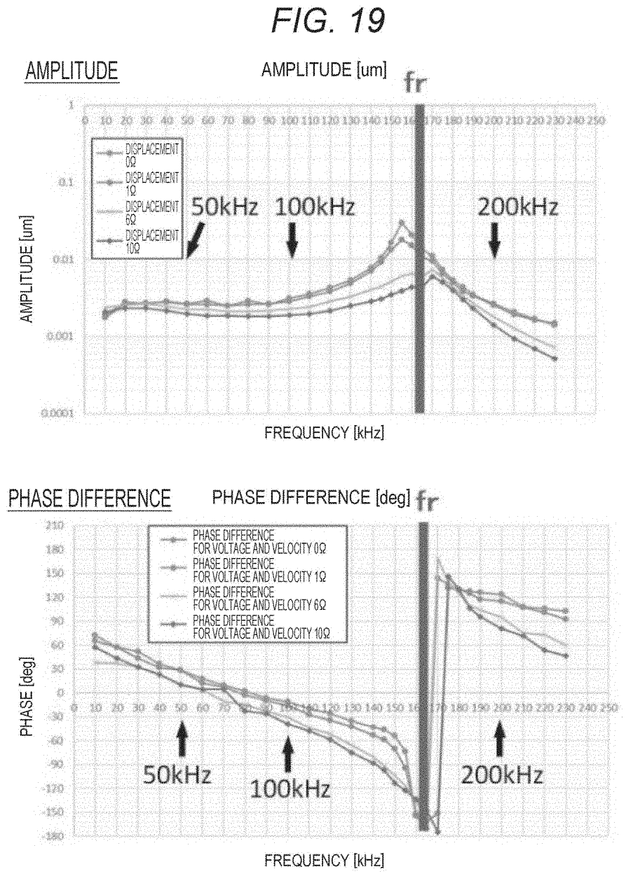

FIG. 19 is a graph illustrating an example of frequency characteristics of a piezo actuator.

In the piezo actuator illustrated in FIG. 19, a self-resonance frequency fr is 160 kHz, and a vibration amplitude starts to rise from around 110 kHz, has a peak at 150 to 170 kHz, and reaches about 10 times of that of 100 kHz or less. Furthermore, a phase continues to be gradually delayed at a constant value of about 10° per 10 kHz at frequencies other than the resonance frequency, but shows a rapid change of ±1800 in 10 kHz before and after 170 kHz. Therefore, in the piezo actuator illustrated in FIG. 19, use at 150 kHz to 170 kHz causes an unstable factor and thus should be avoided.

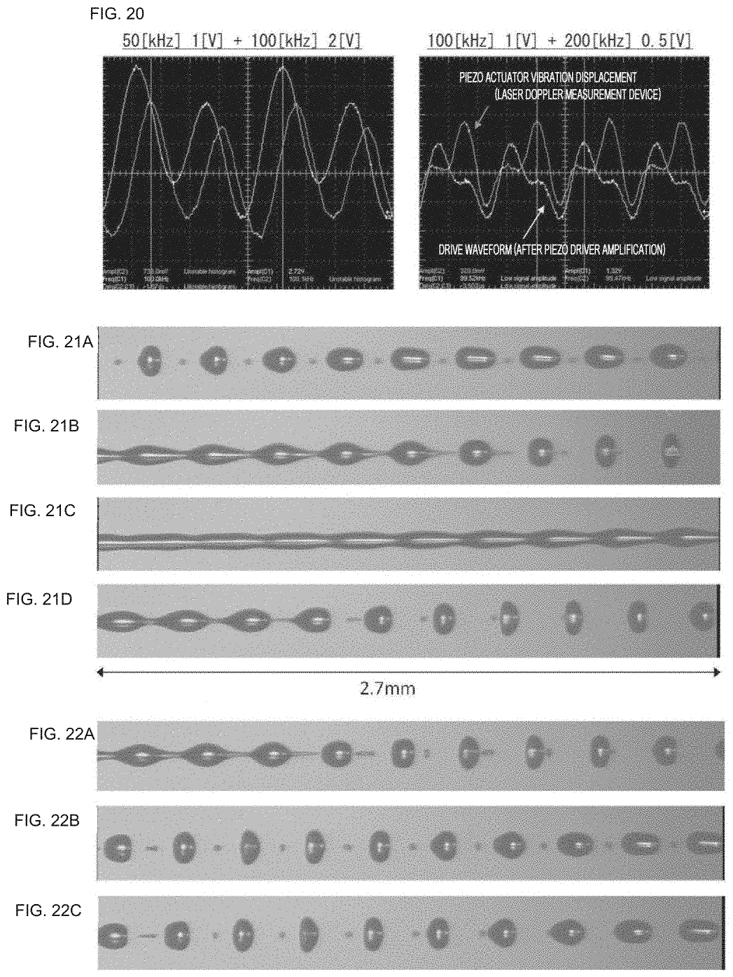

In a combination of the basic wave of 50 kHz and the second harmonic of 100 kHz, amplitudes are substantially the same, and a phase difference is about 50°. Whereas, in a combination of the basic wave of 100 kHz and the second harmonic of 200 kHz, amplitudes are almost equal, but a phase of 200 kHz is advanced by about 140° with respect to 100 kHz. Therefore, it should be noted that a deviation between a superimposed waveform and a piston operation increases as compared with the former combination. FIG. 20 illustrates a comparison result between a piezo actuator drive waveform (after driver amplification) and an actual piston displacement waveform for the two. The piston displacement waveform is obtained by laser Doppler measurement in a state where the actuator is detached from the device and installed in water. In Wf 50 kHz_Wh 100 kHz (the amplitude ratio R=2), the operation of the piston almost traces the drive waveform. However, in Wf 100 kHz_Wh 200 kHz (the amplitude ratio R=0.5), it can be seen that the waveform is inverted in the time axis direction. In particular, in a case where an amplitude change occurs in addition to such a phase change, when the amplitude ratio R of the basic wave and the harmonic described above is adjusted, there is a large difference in expectation in a provisional value at a start of adjustment. Therefore, it is desirable to perform such measurement in advance and grasp characteristics.

<Liquid Feeding System>

At a start of liquid feeding, the flow velocity V of the jet is determined in accordance with a droplet frequency. The jet includes the cell liquid and the sheath liquid, but the jet is governed by a flow velocity of the sheath liquid since the sheath liquid occupies most of a volume. Therefore, first, a pressure P is applied to a pressurized tank for the sheath liquid by an air compressor, and a valve is opened to start a fluid flow. When a pressure loss of a liquid feeding system is PL, a relationship with the flow velocity V is “P≈(½)×(ρ×V²)+PL”. (ρ; Sheath liquid density)

Most of the pressure loss is generated at the nozzle portion where the flow path is thinnest, but (½)×(ρ×V²) is dominant at a flow velocity of 30 m/s. In a case where a 70 μm diameter nozzle is used for 100 kHz droplets, an optimum value of a droplet interval is 4.5×70 μm=315 μm based on the Rayleigh theory described above, and the flow velocity V=31.5 m/s is obtained. Therefore, the pressure required for forming the jet with the flow velocity V=31.5 m/s is 500 kPa according to the above formula (½)×(ρ×V²), and a reference of the required pressure P is approximately 600 to 800 kPa when the pressure loss PL of the system is added thereto.

Pressure fluctuations cause changes in BOP and directly affect a deflection state, and thus require precise management. Therefore, the pressure P is controlled using an electropneumatic regulator having an accuracy of ±0.1% or less. The cell liquid is injected into a center part of the sheath liquid to form a central laminar flow called a core stream, and is discharged from the nozzle. Similarly to the sheath liquid, the cell liquid is also fed by pressurizing a cell liquid tank with an air compressor. At that time, a core stream diameter is controlled by giving a change amount ΔP of around 10% with respect to the pressure P of the sheath liquid.

In the present example, the sheath pressure P was set to 550 kPa and the jet flow velocity V was set to 27 m/s for a frequency f of 100 kHz. Between the droplet interval λ=270 μm and the nozzle diameter 70 μm, a ratio λ/d=3.9 is obtained, which is about ⅛ lower than the recommended value 4.5. This is to reduce a distance between droplets, and facilitate a transition of satellites between SLOW and FAST. Note that, as the sheath liquid, IsoFlow sheath liquid dedicated to a flow cytometer and manufactured by Beckman Coulter, Inc. was used.

<Example of Satellite Control by High-Frequency Superimposed Waveform>

The FAST satellites were generated using the superimposed waveform Ws obtained by a combination of the basic sinusoidal wave Wf of f=100 kHz and double sinusoidal wave Wh of fh=200 kHz.

A piezo driver signal output of the basic wave Wf was fixed to 1.2 V, and a signal output of Wh was changed to adjust the amplitude ratio R between the two. FIG. 21 to 23 each illustrate results of observing a state of satellites while rotating a phase of Wh by 360°, for three types of amplitude ratios R=½, ⅙, and 1/12.

Furthermore, A of FIG. 24 illustrates a waveform of two types of phase differences for a superimposed waveform having the amplitude ratio R=⅙, and B of FIG. 24 similarly illustrates a superimposed waveform having R= 1/12.

At the amplitude ratio R=⅙, there was no stepwise waveform change or fold back as seen at the amplitude ratio R=½ illustrated in FIG. 6, and the sinusoidal wave had a shape inclined in the time axis direction. At the amplitude ratio R= 1/12, the shape was almost indistinguishable from the sinusoidal wave.

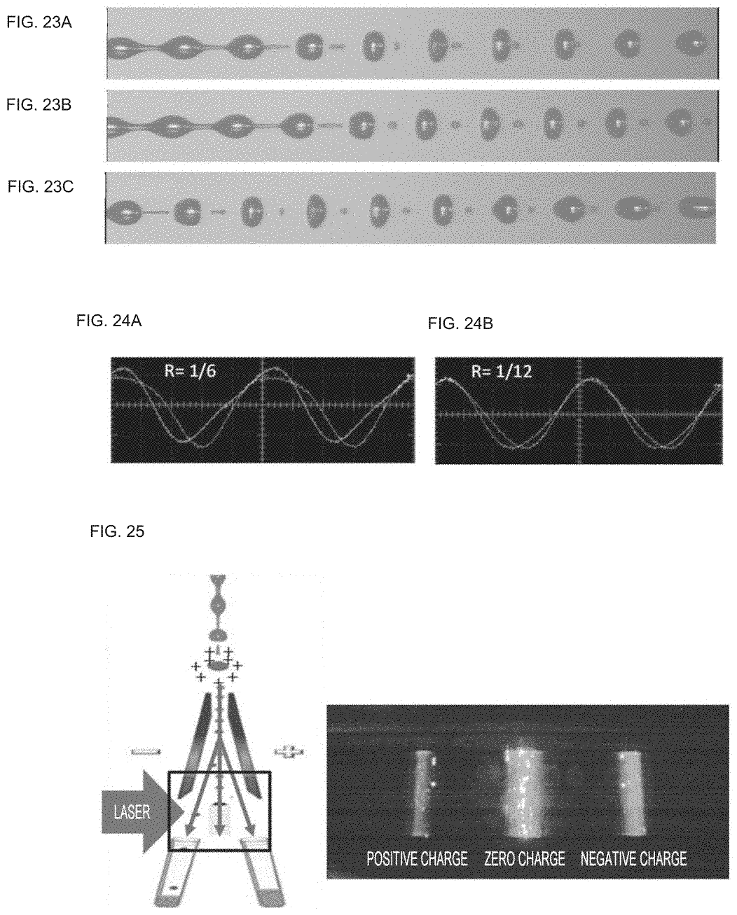

First, for R=½, it can be seen that a transition is made to the INFINITY satellite in A of FIG. 21, to the SLOW satellite in B of FIG. 21, and then to the FAST satellite in D of FIG. 21 while the BOP is changed with rotation of the phase. However, the BOP fluctuation is large, and is not within the range of the droplet observation image, which has a visual field of 2.7 mm in the flow direction. In particular, in C of FIG. 21, the BOP extends rapidly, and droplet dividing cannot be seen. FIG. 4 illustrates a result of observing after this point, and jitter is generated in droplets to cause deflection abnormality. In this phase, it is considered that the operation of the piston traces a waveform (see the waveform B type in FIG. 6) in which there is fold back in the middle of the cycle. As described above, since BOP extension and contraction are intense and a jitter region is generated, this condition has a concern about stability for a long time.

Whereas, with R= 1/12, as expected from the waveform in B of FIG. 24, there was substantially no movement from the SLOW satellite in the case of driving only with the basic sinusoidal wave, a transition was made to the INFINITY satellite in B of FIG. 23 as a limit, and the FAST satellite was not formed. However, a position fluctuation of BOP decreased to less than 1 mm, and no jitter region occurred visually.

With R=⅙, which is an intermediate value between the two, a transition to the FAST satellite was possible as seen in C of FIG. 22, a BOP length fluctuation associated with a phase change of Wh was as small as less than 2 mm, and no visible jitter was observed, so that it can be expected to be an appropriate condition.

If the BOP length fluctuation can be suppressed to about 2 mm or less, a change due to an influence of environmental factors during measurement can be reduced. At the same time, since all satellite behaviors at the time of Wh phase adjustment can be tracked in one visual field of the droplet observation image while the camera is fixed, an effect of shortening the adjustment time is also obtained.

<Checking of Deflection Action>

After the condition of R=⅙ was determined, the phase of Wh was adjusted, droplets were charged after the FAST satellite reproduction condition of C of FIG. 22 is fixed, and a deflection action was checked.

A charge signal is synchronized with a piezo drive signal, and a phase of the charge signal is adjusted to match a timing with a droplet formation cycle so that a deflection angle is maximized. In the present example, a test pattern was used in which deflection was made to the positive side and the negative side once every 10 cycles. A pulse width was set to 10 μsec corresponding to one cycle of 100 kHz, and an amplitude was set to ±100 V. Furthermore, a voltage between deflection electrodes is ±2 kV.

A deflection state is illustrated in FIG. 25. A deflected stream subjected to positive and negative charging was narrowed to be equivalent to the FAST-satellite droplet generated only by the conventional basic sinusoidal wave, and was normal. Furthermore, in an environment with a room temperature change of ±0.5° C. or less, a droplet shape and a deflection angle were maintained without any adjustment during 30 minutes. Thereafter, BOP was gradually extended by about 20 to 30 μm, and a slight decrease in deflection angle was observed. At this time, when an output voltage of the superimposed waveform Ws was decreased by 1%, the output voltage was recovered to the initial deflection angle again.

In a series of experiments, it has been confirmed that the technique of the present invention in which a harmonic superimposed waveform is applied to the piezo actuator drive exhibits deflection performance and temporal stability equivalent to those of the conventional basic sinusoidal wave drive, and there is no problem in practicality.

Note that, in the present technology, the following configuration can also be adopted.

[1]

A microparticle sorting device including:
an imaging element configured to acquire an image of fluid and a droplet at a position where liquid discharged from an orifice that generates a stream of the fluid is converted into a droplet; and
a processing unit configured to determine a harmonic superposition amplitude ratio, a harmonic phase difference, and a superimposed wave voltage on the basis of states of a satellite droplet and a break-off point in the image.

[2]

The microparticle sorting device according to [1], in which the harmonic superposition amplitude ratio is determined on the basis of a maximum value and a minimum value of an amplitude ratio.

[3]

The microparticle sorting device according to [1], in which a phase difference is rotated, and the harmonic superposition amplitude ratio is determined on the basis of a state of a break-off point in the image, the state being associated with a phase change.

[4]

The microparticle sorting device according to [1], in which the harmonic phase difference is determined at an angle at which a length of a break-off point in the image is minimized.

[5]

The microparticle sorting device according to any one of [1] to [4], further including:
a vibration element configured to apply vibration to liquid flowing through a flow path that generates a stream of a fluid; and
a vibration application control unit configured to cause an operation to make a displacement waveform of the vibration element to be asymmetric in a time axis direction between a pushing operation and a pulling operation.

[6]

The microparticle sorting device according to [5], in which a displacement waveform of the vibration element is a superimposed frequency of: a sinusoidal wave of a basic frequency; and a harmonic of an integral multiple frequency of the basic frequency.

[7]

The microparticle sorting device according to [6], in which a frequency of the harmonic is one type of frequency separated from a resonance frequency of the vibration element by ±10 kHz or more.

[8]

The microparticle sorting device according to any one of [5] to [7], in which the flow path is formed in a microchip.

[9]

The microparticle sorting device according to [8], in which the microchip further includes: a main flow path through which liquid containing a microparticle flows; a sheath liquid flow path that communicates with the main flow path and supplies sheath liquid; and a sheath liquid supply port configured to introduce the sheath liquid.

[10]

The microparticle sorting device according to [9], further including a connection member attachable to the microchip and having a sheath liquid introduction coupling part to be coupled to the sheath liquid supply port.

[11]

The microparticle sorting device according to [10], in which the vibration element is attached to the connection member.

[12]

The microparticle measuring device according to [11], in which the sheath liquid introduction coupling part has a sheath liquid converging part whose width gradually or partially narrows from the vibration element side toward the sheath liquid supply port side.

[13]

A microparticle sorting device including:
a light irradiation unit configured to irradiate a microparticle with light;
a light detection unit configured to detect light from the microparticle;
an imaging element configured to acquire an image of fluid and a droplet at a position where liquid discharged from an orifice that generates a stream of the fluid is converted into a droplet; and
a processing unit configured to determine a harmonic superposition amplitude ratio, a harmonic phase difference, and a superimposed wave voltage on the basis of states of a satellite droplet and a break-off point in the image.

[14]

A microparticle sorting system including:
an imaging device configured to acquire an image of fluid and a droplet at a position where liquid discharged from an orifice that generates a stream of the fluid is converted into a droplet; and
a processing device configured to determine a harmonic superposition amplitude ratio, a harmonic phase difference, and a superimposed wave voltage on the basis of states of a satellite droplet and a break-off point in the image.

[15]

A microparticle sorting method including:
an imaging step of acquiring an image of fluid and a droplet at a position where liquid discharged from an orifice that generates a stream of the fluid is converted into a droplet; and
a processing step of determining a harmonic superposition amplitude ratio, a harmonic phase difference, and a superimposed wave voltage on the basis of states of a satellite droplet and a break-off point in the image.

### REFERENCE SIGNS LIST

1 Microparticle sorting device
100 Microparticle sorting device
101 Sheath liquid feeding unit
102 Sample liquid feeding unit
103 Light irradiation unit
104 Light detection unit
105 Processing unit
106 Sorting unit
106a Deflection plate
106b Accumulation container
106c Charging unit
107 Storage unit
108 Display unit
109 Input unit
110 Control unit
M Microchip
Ma, Mb Substrate layer
M1 Orifice
M11 Notch
M2 Main flow path
M3 Sample liquid introduction unit
M31 Sample liquid flow path
M4 Sheath liquid introduction unit
M41 Sheath liquid flow path
M5 Suction opening
M51 Suction flow path
M52 Communication port
M61, 62 Narrowing part
M7 Straight part
L1 Diameter of notch M11
L2 Opening diameter of orifice M1
C Connection member
C1 Sample liquid introduction coupling part
C21 Sheath liquid converging part
C3 Vibration element
C4 Electrode
E Imaging element

1. A microparticle sorting device comprising:
an imaging element configured to acquire an image of fluid and a droplet at a position where liquid discharged from an orifice that generates a stream of the fluid is converted into a droplet; and
a processing unit configured to determine a harmonic superposition amplitude ratio, a harmonic phase difference, and a superimposed wave voltage on a basis of states of a satellite droplet and a break-off point in the image.

2. The microparticle sorting device according to claim 1, wherein the harmonic superposition amplitude ratio is determined on a basis of a maximum value and a minimum value of an amplitude ratio.

3. The microparticle sorting device according to claim 1, wherein a phase difference is rotated, and the harmonic superposition amplitude ratio is determined on a basis of a state of a break-off point in the image, the state being associated with a phase change.

4. The microparticle sorting device according to claim 1, wherein the harmonic phase difference is determined at an angle at which a length of a break-off point in the image is minimized.

5. The microparticle sorting device according to claim 1, further comprising:
a vibration element configured to apply vibration to liquid flowing through a flow path that generates a stream of a fluid; and
a vibration application control unit configured to cause an operation to make a displacement waveform of the vibration element to be asymmetric in a time axis direction between a pushing operation and a pulling operation.

6. The microparticle sorting device according to claim 5, wherein a displacement waveform of the vibration element includes a superimposed frequency of: a sinusoidal wave of a basic frequency; and a harmonic of an integral multiple frequency of the basic frequency.

7. The microparticle sorting device according to claim 6, wherein a frequency of the harmonic includes one type of frequency separated from a resonance frequency of the vibration element by ±10 kHz or more.

8. The microparticle sorting device according to claim 5, wherein the flow path is formed in a microchip.

9. The microparticle sorting device according to claim 8, wherein the microchip further includes: a main flow path through which liquid containing a microparticle flows; a sheath liquid flow path that communicates with the main flow path and supplies sheath liquid; and a sheath liquid introduction unit configured to introduce the sheath liquid.

10. The microparticle sorting device according to claim 9, further comprising a connection member attachable to the microchip and having a sheath liquid introduction coupling part to be coupled to the sheath liquid supply port.

11. The microparticle sorting device according to claim 10, wherein the vibration element is attached to the connection member.

12. The microparticle measuring device according to claim 11, wherein the sheath liquid introduction coupling part has a sheath liquid converging part whose width gradually or partially narrows from the vibration element side toward the sheath liquid supply port side.

13. A microparticle sorting device comprising:
a light irradiation unit configured to irradiate a microparticle with light;
a light detection unit configured to detect light from the microparticle;
an imaging element configured to acquire an image of fluid and a droplet at a position where liquid discharged from an orifice that generates a stream of the fluid is converted into a droplet; and
a processing unit configured to determine a harmonic superposition amplitude ratio, a harmonic phase difference, and a superimposed wave voltage on a basis of states of a satellite droplet and a break-off point in the image.

14. A microparticle sorting system comprising:
an imaging device configured to acquire an image of fluid and a droplet at a position where liquid discharged from an orifice that generates a stream of the fluid is converted into a droplet; and
a processing device configured to determine a harmonic superposition amplitude ratio, a harmonic phase difference, and a superimposed wave voltage on a basis of states of a satellite droplet and a break-off point in the image.

15. A microparticle sorting method comprising:
an imaging step of acquiring an image of fluid and a droplet at a position where liquid discharged from an orifice that generates a stream of the fluid is converted into a droplet; and
a processing step of determining a harmonic superposition amplitude ratio, a harmonic phase difference, and a superimposed wave voltage on a basis of states of a satellite droplet and a break-off point in the image.
